(19) United States
(12) Patent Application Publication
(10) Pub. No.: US 2025/0220521 A1
(43) Pub. Date: Jul. 3, 2025

(54) METHOD FOR PROVISIONING OF CONDITIONAL PSCELL CHANGE EXECUTION CONDITION AND MEASUREMENT CONFIGURATION AFTER CONDITIONAL CONFIGURATION EXECUTION

(71) Applicant: Nokia Technologies Oy, Espoo (FI)

(72) Inventors: Halit Murat GÜRSU, Munich (DE); Ahmad AWADA, Munich (DE); Panagiotis SPAPIS, Munich (DE); Umur KARABULUT, Munich (DE); Jedrzej STANCZAK, Wroclaw (PL); Krzysztof KORDYBACH, Wroclaw (PL)

(21) Appl. No.: 18/850,412

(22) PCT Filed: Mar. 29, 2022
(86) PCT No.: PCT/US2022/022254

§ 371 Date: Sep. 24, 2024

(51) Int. Cl. H04W 36/00; H04W 36/36

(52) U.S. Cl. CPC H04W 36/0069; H04W 36/0016; H04W 36/0085; H04W 36/362

(57) ABSTRACT

In accordance with example embodiments of the invention there is at least a method and apparatus to perform preparing a conditional cell change in a cellular communication network supporting dual connectivity, comprising: sending, by a master node of the cellular communication network, towards a first target secondary node a message comprising an indication of at least one primary cell of a secondary cell group cell of at least a second target secondary node prepared or to be prepared for a conditional primary cell of a secondary cell group change for a user equipment from a primary cell of a secondary cell group of a secondary node to a primary cell of a secondary cell group of at least a second target secondary node, wherein the message enables, at the first target secondary node, configuration of conditional primary cell of a secondary cell group change execution condition for at least one of the prepared primary cells of a secondary cell group of the at least one second target secondary node for conditional primary cell of a secondary cell group change for the user equipment from a primary cell of a secondary cell group of a first target secondary node to a primary cell of a secondary cell group of at least a second target secondary node.

### TECHNICAL FIELD

The teachings in accordance with the exemplary embodiments of this invention relate generally to proper synchronization of conditional primary cell of secondary cell group changes and, more specifically, relate to proper synchronization with low signalling overhead on conditional Primary cell of secondary cell group change execution conditions that need to be evaluated after each conditional Primary cell of secondary cell group change execution.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
PSCell Primary cell of secondary cell group
PCell Primary cell of master cell group
MN Master node
SN Secondary node
RRC Radio resource control
CPC Conditional PSCell Change
CPAC Conditional PSCell Addition or Change
UE User equipment
MCG Master cell group
SCG Secondary cell group
CHO Conditional Handover
DC Dual Connectivity

At the time of this application, in a 3GPP paradigm for inter-SN CPC the entity that initiates the CPC procedure is responsible for deciding on the list of target PSCells that may be prepared along with its corresponding CPC execution conditions. However, the target SN cannot prepare beyond maximum number of PSCells that is sent by the initiating node (Source SN).

Likewise, at the time of this application in the SN-initiated inter-SN CPC, the source SN is responsible to set the execution condition for each target PSCell that may possibly be prepared. The CPC execution condition refers to a measurement ID in a measurement configuration that is provided by the initiating node which is the source SN in this case.

Example embodiments of the invention work to address at least these issues and provide improvements.

### SUMMARY

This section contains examples of possible implementations and is not meant to be limiting.

In an example aspect of the invention, there is an apparatus, such as a network side apparatus, comprising: at least one processor; and at least one non-transitory memory including computer program code, where the at least one memory and the computer program code are configured, with the at least one processor, to cause the apparatus to at least: prepare a conditional cell change in a cellular communication network supporting dual connectivity, comprising: sending, by a master node of the cellular communication network, towards a first target secondary node a message comprising an indication of at least one primary secondary cell group cell of at least a second target secondary node prepared for a conditional primary cell of a secondary cell group change primary cell of a secondary cell group change for a user equipment from a primary secondary cell group cell of a secondary node to a primary secondary cell group cell of at least a second target secondary node, wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node; receiving, from the first target secondary node, a message comprising an indication of at least one of the configured conditional primary cell of a secondary cell group change execution conditions; and sending, by the master node, towards the user equipment a message comprising an indication of at least one configured conditional primary cell of a secondary cell group change execution condition.

In another example aspect of the invention, there is a method comprising: preparing a conditional cell change in a cellular communication network supporting dual connectivity, comprising: sending, by a master node of the cellular communication network, towards a first target secondary node a message comprising an indication of at least one primary secondary cell group cell of at least a second target secondary node prepared for a conditional primary cell of a secondary cell group change for a user equipment from a primary secondary cell group cell of a secondary node to a primary secondary cell group cell of at least a second target secondary node, wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node; receiving, from the first target secondary node, a message comprising an indication of at least one of the configured conditional primary cell of a secondary cell group change execution conditions; and sending, by the master node, towards the user equipment a message comprising an indication of at least one configured conditional primary cell of a secondary cell group change execution condition.

A further example embodiment is an apparatus and a method comprising the apparatus and the method of the previous paragraphs, wherein there is receiving from the first target secondary node information comprising a set of updated execution condition and related measurement configuration for at least one of the prepared primary secondary cell group cells, wherein the information comprises: a conditional primary cell of a secondary cell group change execution condition and updated measurement configurations for the primary secondary cell group cells of the second target secondary node, and at least one of a conditional primary secondary cell group cell addition or change incoming probability for at least one kept conditional primary cell of a secondary cell group change associated with the first target secondary node and the second target secondary node, and a maximum number of primary secondary cell group cells supported by the first target secondary node, wherein the set of updated execution conditions and updated measurement configurations are included in a secondary node modification required request sent from the first target secondary node and received by the master node, wherein the incoming probability for at least one kept conditional primary cell of a secondary cell group change and the maximum number of primary secondary cell group cells are included in a secondary node modification request sent from the master node towards the second target secondary node, and/or, wherein the method further comprises: receiving, by the master node a message from the user equipment comprising an indication that the user equipment executes a conditional primary cell of a secondary cell group change towards a primary secondary cell group cell of the first target secondary node.

A non-transitory computer-readable medium storing program code, the program code executed by at least one processor to perform at least the method as described in the paragraphs above.

In another example aspect of the invention, there is an apparatus comprising: means for preparing a conditional cell change in a cellular communication network supporting dual connectivity, comprising: means for sending, by a master node of the cellular communication network, towards a first target secondary node a message comprising an indication of at least one primary secondary cell group cell of at least a second target secondary node prepared for a conditional primary cell of a secondary cell group change for a user equipment from a primary secondary cell group cell of a secondary node to a primary secondary cell group cell of at least a second target secondary node, wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node; means for receiving, from the first target secondary node, a message comprising an indication of at least one of the configured conditional primary cell of a secondary cell group change execution conditions; and means for sending, by the master node, towards the user equipment a message comprising an indication of at least one configured conditional primary cell of a secondary cell group change execution condition.

In accordance with the example embodiments as described in the paragraph above, at least the means for sending and receiving comprises a network interface, and computer program code stored on a computer-readable medium and executed by at least one processor.

In an example aspect of the invention, there is an apparatus, such as a network side apparatus, comprising: at least one processor; and at least one non-transitory memory including computer program code, where the at least one memory and the computer program code are configured, with the at least one processor, to cause the apparatus to at least: send, by a master node of a cellular communication network, information towards a second target secondary node prepared for a conditional primary cell of a secondary cell group change for a user equipment from a primary secondary cell group cell of a secondary node to a primary secondary cell group cell of at least the second target secondary node, wherein the information identifies a list of other prepared primary cells of a secondary cell group, and wherein the information causes the second target secondary node to make use of the list to provide a measurement configuration and execution condition for each of prepared primary cells of a secondary cell group such that the user equipment is able to switch from a primary cell of a secondary cell group of the second target secondary node to the one of the other prepared primary cells of a secondary cell group that are indicated by master node to the second target secondary node.

In another example aspect of the invention, there is a method comprising: sending, by a master node of a cellular communication network, information towards a second target secondary node prepared for a conditional primary cell of a secondary cell group change for a user equipment from a primary secondary cell group cell of a secondary node to a primary secondary cell group cell of the second target secondary node, wherein the information includes at least one prepared primary secondary cell group cell of a first target secondary node, and wherein the information enables the second target secondary node to provide a measurement configuration and execution condition for a conditional primary cell of a secondary cell group change from a primary secondary cell group cell of the second target secondary node to a primary secondary cell group cell of the first target secondary node, receiving by the master node at least one configuration including a measurement configuration and execution condition for a conditional primary cell of a secondary cell group change from a primary secondary cell group cell of the second target secondary node to a primary secondary cell group cell of the first target secondary node in case a conditional primary cell of a secondary cell group change is executed for the user equipment from the secondary node towards the second target secondary node.

A further example embodiment is an apparatus and a method comprising the apparatus and the method of the previous paragraphs, wherein based on the sending, there is receiving from the second target secondary node at least one of: a first configuration to be used if the conditional primary cell of a secondary cell group change is executed towards a first cell of the second target secondary node, or a second configuration to be used if the conditional primary cell of a secondary cell group change is executed towards a second cell of the second target secondary node, wherein the first configuration and the second configuration comprise measurement configurations for conditional primary cell of a secondary cell group change execution conditions associated with a conditional primary secondary cell group cell addition or change incoming probability from a first target secondary node to the second target secondary node, or vice versa, wherein there is receiving from the first target secondary node information comprising a configuration for the primary cell of a secondary cell group, wherein the information comprises a conditional primary cell of a secondary cell group execution condition from the first target secondary node to the second target secondary node, or vice versa, wherein the information comprises a measurement configuration comprising a configuration of conditional primary cell of a secondary cell group execution conditions, and a conditional primary secondary cell group cell addition or change incoming probability from a first target secondary node to the second target secondary node, or vice versa.

A non-transitory computer-readable medium storing program code, the program code executed by at least one processor to perform at least the method as described in the paragraphs above.

In another example aspect of the invention, there is an apparatus comprising: means for sending, by a master node of a cellular communication network, information towards a second target secondary node prepared for a conditional primary cell of a secondary cell group change for a user equipment from a primary secondary cell group cell of a secondary node to a primary secondary cell group cell of at least the second target secondary node, wherein the information identifies a list of other prepared primary cells of a secondary cell group, and wherein the information causes the second target secondary node to make use of the list to provide a measurement configuration and execution condition for each of prepared primary cells of a secondary cell group such that the user equipment is able to switch from a primary cell of a secondary cell group of the second target secondary node to the one of the other prepared primary cells of a secondary cell group that are indicated by master node to the second target secondary node.

In accordance with the example embodiments as described in the paragraph above, at least the means for sending comprises a network interface, and computer program code stored on a computer-readable medium and executed by at least one processor.

In an example aspect of the invention, there is an apparatus, such as a network side apparatus, comprising: at least one processor; and at least one non-transitory memory including computer program code, where the at least one memory and the computer program code are configured, with the at least one processor, to cause the apparatus to at least: trigger, by a source secondary node for a secondary node primary cell of a secondary cell group change preparation of conditional primary cell of a secondary cell group change, wherein the preparation of conditional primary cell of a secondary cell group change is based on measurements received from user equipment, and wherein the triggering is performed without providing a conditional primary cell of a secondary cell group change execution condition.

In another example aspect of the invention, there is a method comprising: triggering, by a source secondary node for a secondary node primary cell of a secondary cell group change preparation of conditional primary cell of a secondary cell group change, wherein the preparation of conditional primary cell of a secondary cell group change is based on measurements received from user equipment, and wherein the triggering is performed without providing a conditional primary cell of a secondary cell group change execution condition.

A further example embodiment is an apparatus and a method comprising the apparatus and the method of the previous paragraphs, wherein there is sending towards a master node information comprising at least one of a global or physical cell identity of a prepared target primary cell of a secondary cell group for the primary cell change execution for the user equipment, wherein there is receiving from the master node an identification of conditional reconfigurations that are associated with the prepared target primary cell of the secondary cell group, wherein based on the receiving, there is sending towards the user equipment a radio resource control reconfiguration command and an identification instructing the user equipment to execute the conditional reconfigurations of a specific target primary cell of a secondary cell group identified by the identification.

A non-transitory computer-readable medium storing program code, the program code executed by at least one processor to perform at least the method as described in the paragraphs above.

In another example aspect of the invention, there is an apparatus comprising: means for triggering, by a source secondary node for a secondary node primary cell of a secondary cell group change preparation of conditional primary cell of a secondary cell group change, wherein the preparation of conditional primary cell of a secondary cell group change is based on measurements received from user equipment, and wherein the triggering is performed without providing a conditional primary cell of a secondary cell group change execution condition.

In accordance with the example embodiments as described in the paragraph above, at least the means for triggering comprises a network interface, and computer program code stored on a computer-readable medium and executed by at least one processor.

In an example aspect of the invention, there is an apparatus, such as a network side apparatus, comprising: at least one processor; and at least one non-transitory memory including computer program code, where the at least one memory and the computer program code are configured, with the at least one processor, to cause the apparatus to at least: prepare a conditional cell change in a cellular communication network supporting dual connectivity, comprising: receiving, by a first target secondary node of the cellular communication network, from a master node a message comprising an indication of at least one primary secondary cell group cell of at least a second target secondary node prepared for a conditional primary cell of a secondary cell group change for a user equipment from a primary secondary cell group cell of a secondary node to a primary secondary cell group cell of at least a second target secondary node, wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node; send, towards the master node, a message comprising an indication of at least one of the configured conditional primary cell of a secondary cell group change execution conditions, wherein the sending causes an indication of at least one configured conditional primary cell of a secondary cell group change execution condition to be sent towards the user equipment.

In another example aspect of the invention, there is a method comprising: preparing a conditional cell change in a cellular communication network supporting dual connectivity, comprising: receiving, by a first target secondary node of the cellular communication network, from a master node a message comprising an indication of at least one primary secondary cell group cell of at least a second target secondary node prepared for a conditional primary cell of a secondary cell group change for a user equipment from a primary secondary cell group cell of a secondary node to a primary secondary cell group cell of at least a second target secondary node, wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node; sending, towards the master node, a message comprising an indication of at least one of the configured conditional primary cell of a secondary cell group change execution conditions, and wherein the sending causes an indication of at least one configured conditional primary cell of a secondary cell group change execution condition to be sent towards the user equipment.

A further example embodiment is an apparatus and a method comprising the apparatus and the method of the previous paragraphs, wherein there is sending towards the master node information comprising a set of updated execution condition and related measurement configuration for each of the prepared primary secondary cell group cells, wherein the information comprises: a conditional primary cell of a secondary cell group change execution condition and updated measurement configurations for the primary secondary cell group cells for the first target secondary node and the second target secondary node, and at least one conditional primary secondary cell group cell addition or change incoming probability for at least one kept conditional primary cell of a secondary cell group change associated with the first target secondary node and the second target secondary node and for a maximum number of primary secondary cell group cells that can be initiated by the second target secondary node, wherein the set of updated execution conditions and updated measurement configurations are at least based on a secondary node modification required request sent from the first target secondary node to the master node.

A non-transitory computer-readable medium storing program code, the program code executed by at least one processor to perform at least the method as described in the paragraphs above.

In another example aspect of the invention, there is an apparatus comprising: means for preparing a conditional cell change in a cellular communication network supporting dual connectivity, comprising: means for receiving, by a first target secondary node of the cellular communication network, from a master node a message comprising an indication of at least one primary secondary cell group cell of at least a second target secondary node prepared for a conditional primary cell of a secondary cell group change for a user equipment from a primary secondary cell group cell of a secondary node to a primary secondary cell group cell of at least a second target secondary node, wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node; and means for sending, towards the master node, a message comprising an indication of at least one of the configured conditional primary cell of a secondary cell group change execution conditions, wherein the sending causes an indication of at least one configured conditional primary cell of a secondary cell group change execution condition to be sent towards the user equipment.

In accordance with the example embodiments as described in the paragraph above, at least the means for preparing, receiving, and sending and receiving comprises a network interface, and computer program code stored on a computer-readable medium and executed by at least one processor.

In another example aspect of the invention, there is an apparatus, such as a network side apparatus, comprising: at least one processor; and at least one non-transitory memory including computer program code, where the at least one memory and the computer program code are configured, with the at least one processor, to cause the apparatus to at least: receive, by a second target secondary node from a master node of a cellular communication network, information prepared for a conditional primary cell of a secondary cell group change for a user equipment from a primary secondary cell group cell of a secondary node to a primary secondary cell group cell of at least the second target secondary node, wherein the information identifies a list of other prepared primary cells of a secondary cell group, and based on the information, using the list to provide to the master node a measurement configuration and execution condition for each of prepared primary cells of a secondary cell group such that the user equipment is able to switch from a primary cell of a secondary cell group of the second target secondary node to the one of the other prepared primary cells of a secondary cell group that are indicated by master node to the second target secondary node.

In another example aspect of the invention, there is a method comprising: receiving, by a second target secondary node from a master node of a cellular communication network, information prepared for a conditional primary cell of a secondary cell group change for a user equipment from a primary secondary cell group cell of a secondary node to a primary secondary cell group cell of at least the second target secondary node, wherein the information identifies a list of other prepared primary cells of a secondary cell group, and based on the information, using the list to provide to the master node a measurement configuration and execution condition for each of prepared primary cells of a secondary cell group such that the user equipment is able to switch from a primary cell of a secondary cell group of the second target secondary node to the one of the other prepared primary cells of a secondary cell group that are indicated by master node to the second target secondary node.

A further example embodiment is an apparatus and a method comprising the apparatus and the method of the previous paragraphs, wherein there is, based on the receiving, sending towards the master node at least one of: a first configuration to be used if the conditional primary cell of a secondary cell group change is executed towards a first cell of the second target secondary node, or a second configuration to be used if the conditional primary cell of a secondary cell group change is executed towards a second cell of the second target secondary node, wherein the first configuration and the second configuration comprise measurement configurations for conditional primary cell of a secondary cell group change execution conditions associated with a conditional primary secondary cell group cell addition or change incoming probability from a first target secondary node to the second target secondary node, or vice versa, wherein there is receiving from the first target secondary node information comprising a configuration for the primary cell of a secondary cell group, wherein the information comprises a conditional primary cell of a secondary cell group execution condition from the first target secondary node to the second target secondary node, or vice versa, wherein the information comprises a measurement configuration comprising a configuration of conditional primary cell of a secondary cell group execution conditions, a conditional primary secondary cell group cell addition or change incoming probability from a first target secondary node to the second target secondary node, or vice versa, and wherein the second target secondary node makes use of this list to provide a measurement configuration and execution condition for each other prepared primary cells of secondary cell group such that the user equipment is able to switch from the primary cell of secondary cell group of the second target secondary node to the one of the other prepared primary cell of secondary cell group that are indicated by the master node to target second target secondary node.

A non-transitory computer-readable medium storing program code, the program code executed by at least one processor to perform at least the method as described in the paragraphs above.

In another example aspect of the invention, there is an apparatus comprising: means, for receiving, by a second target secondary node from a master node of a cellular communication network, information prepared for a conditional primary cell of a secondary cell group change for a user equipment from a primary secondary cell group cell of a secondary node to a primary secondary cell group cell of at least the second target secondary node, wherein the information identifies a list of other prepared primary cells of a secondary cell group, and means, based on the information, for using the list to provide to the master node a measurement configuration and execution condition for each of prepared primary cells of a secondary cell group such that the user equipment is able to switch from a primary cell of a secondary cell group of the second target secondary node to the one of the other prepared primary cells of a secondary cell group that are indicated by master node to the second target secondary node.

In accordance with the example embodiments as described in the paragraph above, at least the means for receiving, and using comprises a network interface, and computer program code stored on a computer-readable medium and executed by at least one processor.

In another example aspect of the invention, there is an apparatus, such as a network side apparatus, comprising: at least one processor; and at least one non-transitory memory including computer program code, where the at least one memory and the computer program code are configured, with the at least one processor, to cause the apparatus to at least: trigger, by a source secondary node for a secondary node primary cell of a secondary cell group change preparation of conditional primary cell of a secondary cell group change, wherein the preparation of conditional primary cell of a secondary cell group change is based on measurements received from user equipment, and wherein the triggering is performed without providing a conditional primary cell of a secondary cell group change execution condition.

In another example aspect of the invention, there is a method comprising: triggering, by a source secondary node for a secondary node primary cell of a secondary cell group change preparation of conditional primary cell of a secondary cell group change, wherein the preparation of conditional primary cell of a secondary cell group change is based on measurements received from user equipment, and wherein the triggering is performed without providing a conditional primary cell of a secondary cell group change execution condition.

A non-transitory computer-readable medium storing program code, the program code executed by at least one processor to perform at least the method as described in the paragraphs above.

A further example embodiment is an apparatus and a method comprising the apparatus and the method of the previous paragraphs, wherein there is sending towards a master node information comprising at least one of a global or physical cell identity of a prepared target primary cell of a secondary cell group for the primary cell change execution for the user equipment, wherein there is receiving from the master node an identification of conditional reconfigurations that are associated with the prepared target primary cell of the secondary cell group, wherein based on the receiving, sending towards the user equipment a radio resource control reconfiguration command and an identification instructing the user equipment to execute the conditional reconfigurations of a specific target primary cell of a secondary cell group identified by the identification.

A non-transitory computer-readable medium storing program code, the program code executed by at least one processor to perform at least the method as described in the paragraphs above.

In another example aspect of the invention, there is an apparatus comprising: means for triggering, by a source secondary node for a secondary node primary cell of a secondary cell group change preparation of conditional primary cell of a secondary cell group change, wherein the preparation of conditional primary cell of a secondary cell group change is based on measurements received from user equipment, and wherein the triggering is performed without providing a conditional primary cell of a secondary cell group change execution condition.

In accordance with the example embodiments as described in the paragraph above, at least the means for triggering comprises a network interface, and computer program code stored on a computer-readable medium and executed by at least one processor.

In another example aspect of the invention, there is an apparatus, such as a user equipment side apparatus, comprising: at least one processor; and at least one non-transitory memory including computer program code, where the at least one memory and the computer program code are configured, with the at least one processor, to cause the apparatus to at least: receive, by a user equipment from a master node, information comprising an indication of at least one configured conditional primary cell of a secondary cell group change execution condition for a conditional primary cell of a secondary cell group change for the user equipment from a primary secondary cell group cell of a secondary node to a primary secondary cell group cell of at least a second target secondary node; and based on the information, perform the conditional primary cell of a secondary cell group change.

In another example aspect of the invention, there is a method comprising: receiving, by a user equipment from a master node, information comprising an indication of at least one configured conditional primary cell of a secondary cell group change execution condition for a conditional primary cell of a secondary cell group change for the user equipment from a primary secondary cell group cell of a secondary node to a primary secondary cell group cell of at least a second target secondary node; and based on the information, performing the conditional primary cell of a secondary cell group change

In another example aspect of the invention, there is an apparatus comprising: means for receiving, by a user equipment from a master node, information comprising an indication of at least one configured conditional cell of a secondary cell group change execution condition for a conditional primary cell of a secondary cell group change for the user equipment from a primary secondary cell group cell of a secondary node to a primary secondary cell group cell of at least a second target secondary node; and means, based on the information, for performing the conditional primary cell of a secondary cell group change.

In accordance with the example embodiments as described in the paragraph above, at least the means for receiving and performing comprises a network interface, and computer program code stored on a computer-readable medium and executed by at least one processor.

In another example aspect of the invention, there is an apparatus, such as a user equipment side apparatus, comprising: at least one processor; and at least one non-transitory memory including computer program code, where the at least one memory and the computer program code are configured, with the at least one processor, to cause the apparatus to at least: send, by a user equipment towards a source secondary node of a cellular communication network, measurements based on a measurement configuration from a target secondary node, wherein the sending causes triggering by the source secondary node for a secondary node primary cell of a secondary cell group change preparation of conditional primary cell of a secondary cell group change, and wherein the triggering is performed without providing a conditional primary cell of a secondary cell group change execution condition.

In another example aspect of the invention, there is a method comprising: sending, by a user equipment towards a source secondary node of a cellular communication network, measurements based on a measurement configuration from a target secondary node, wherein the sending causes triggering by the source secondary node for a secondary node primary cell of a secondary cell group change preparation of conditional primary cell of a secondary cell group change, and wherein the triggering is performed without providing a conditional primary cell of a secondary cell group change execution condition.

In another example aspect of the invention, there is an apparatus comprising: means for sending, by a user equipment towards a source secondary node of a cellular communication network, measurements based on a measurement configuration from a target secondary node, wherein the sending causes means for triggering by the source secondary node for a secondary node primary cell of a secondary cell group change preparation of conditional primary cell of a secondary cell group change, and wherein the triggering is performed without providing a conditional primary cell of a secondary cell group change execution condition.

In accordance with the example embodiments as described in the paragraph above, at least the means for sending and triggering comprises a network interface, and computer program code stored on a computer-readable medium and executed by at least one processor.

In another example aspect of the invention, there is an apparatus, such as a user equipment side apparatus, comprising: at least one processor; and at least one non-transitory memory including computer program code, where the at least one memory and the computer program code are configured, with the at least one processor, to cause the apparatus to at least: receive, by a user equipment from a master node, information comprising the preparation of a conditional cell of a secondary cell group change for the user equipment from a primary secondary cell group cell of a secondary node to a primary secondary cell group cell of a second target secondary node; send, by a user equipment, measurements related to at least one of the first and/or the second target secondary node, wherein the sending causes enabling checking an execution condition for the conditional primary cell of a secondary cell group change based on the measurements, and receive, by the user equipment, information comprising the execution of the primary cell of a secondary cell group change for the user equipment from a primary secondary cell group cell of a secondary node to a primary secondary cell group cell of the first or second target secondary node.

In another example aspect of the invention, there is a method comprising: receiving, by a user equipment from a master node, information comprising the preparation of a conditional primary cell of a secondary cell group change for the user equipment from a primary secondary cell group cell of a secondary node to a primary secondary cell group cell of a second target secondary node; sending, by a user equipment, measurements related to at least one of the first and/or the second target secondary node, wherein the sending causes enabling checking an execution condition for the conditional primary cell of a secondary cell group change based on the measurements, and receiving, by the user equipment, information comprising the execution of the primary cell of a secondary cell group change for the user equipment from a primary secondary cell group cell of a secondary node to a primary secondary cell group cell of the first or second target secondary node.

A further example embodiment is an apparatus and a method comprising the apparatus and the method of the previous paragraphs, wherein there is receiving at least one of a global or physical cell identity of a prepared target primary cell of a secondary cell group for the primary cell change execution for the user equipment receiving from the second target secondary node information comprising a configuration for a first primary cell, wherein the configuration adds conditional primary cell of secondary cell group change execution conditions for switching from the first primary cell of secondary cell group to at least one of a second primary cell of secondary cell group, wherein the information comprises a conditional primary cell of a secondary cell group addition or change probability from the first primary cell of secondary cell group to at least one of a second primary cell of secondary cell group, or vice versa, wherein there is using the configuration to monitoring the conditional primary cell of secondary cell group change execution condition of the configuration from the first primary cell of secondary cell group to the at least one of a second primary cell of secondary cell group.

In another example aspect of the invention, there is an apparatus comprising: means for sending, by a user equipment towards a source secondary node of a cellular communication network, measurements based on a measurement configuration from a target secondary node, wherein the sending causes means for triggering by the source secondary node for a secondary node primary cell of a secondary cell group change preparation of conditional primary cell of a secondary cell group change, and wherein the triggering is performed without providing a conditional primary cell of a secondary cell group change execution condition.

In accordance with the example embodiments as described in the paragraph above, at least the means for sending and triggering comprises a network interface, and computer program code stored on a computer-readable medium and executed by at least one processor.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a secondary node initiated Inter-SN Conditional Primary Secondary Cell Change;

FIG. 2 shows a conditional primary cell of secondary cell group change configuration for secondary node initiated inter-SN conditional PSCell change;

FIG. 3 shows conditional primary cell of secondary cell group change configuration for secondary node initiated inter-SN primary cell of secondary cell group after conditional primary cell of secondary cell group change execution towards primary cell of secondary cell group 1-1;

FIG. 4 shows a message sequence chart on consecutive conditional handover [R2-1909862];

FIG. 5 shows a message sequence chart for embodiment 1 in accordance with example embodiments of the invention;

FIG. 6 shows a message sequence chart for embodiment 2 in accordance with example embodiments of the invention;

FIG. 7A shows a message sequence chart for embodiment 3 alternative 1 in accordance with example embodiments of the invention;

FIG. 7B shows a message sequence chart for embodiment 3 alternative 2 in accordance with example embodiments of the invention;

FIG. 8 shows a high level block diagram of various devices used in carrying out various aspects of the invention; and

FIG. 9A, FIG. 9B, 9C, 9D, 9E, 10A, 10B, 10C, 10D, 10E, 10F, 10G, 11A, 11B, 11C, and 11D each show a method in accordance with example embodiments of the invention which may be performed by an apparatus.

### DETAILED DESCRIPTION

In example embodiments of this invention, there is provided at least a method and apparatus for proper synchronization with low signalling overhead on conditional Primary cell of secondary cell group change execution conditions that need to be evaluated after each conditional Primary cell of secondary cell group change execution.

### Conditional PSCell Addition and Change

At the time of this application it has been submitted that CPC be extended in standards for inter-SN scenarios, where it has two types: MN-initiated CPC and SN-initiated CPC.

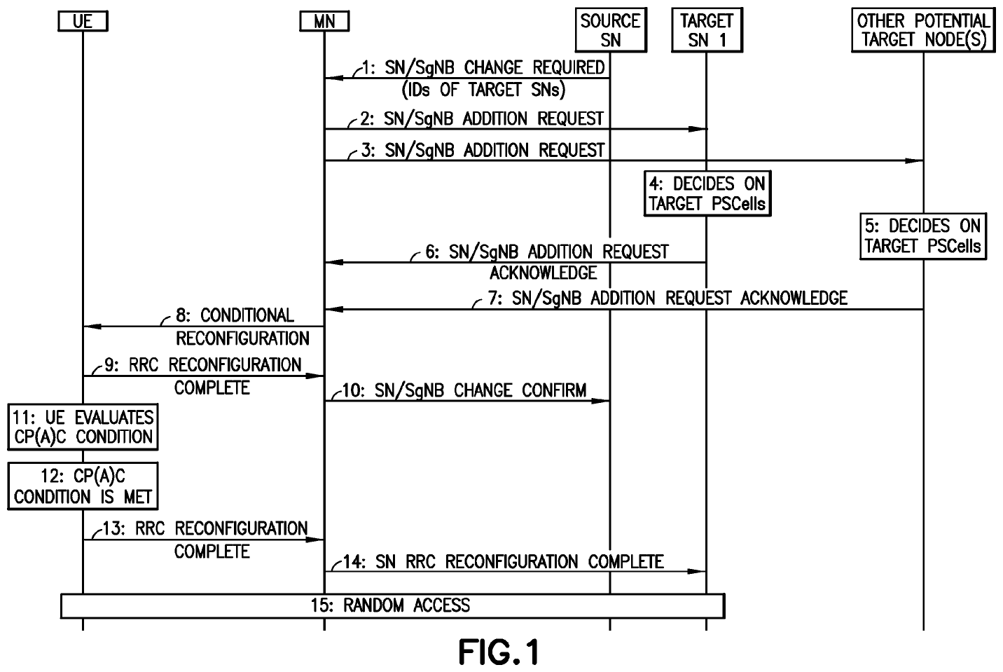

This is illustrated in FIG. 1 which shows an exemplary signalling diagram for a secondary node initiated Inter-SN Conditional Primary Secondary Cell Change:
In step 1 of FIG. 1, the source SN indicates to MN the IDs of the target SNs that shall be contacted for preparing target PSCell(s). The source SN suggests a list of PSCell(s) to be prepared by each target SN and provide a CPC execution condition for each suggested target PSCell;
In step 2/3 of FIG. 1, MN sends an addition request to each target SN indicated by the source SN;
In step 4/5 of FIG. 1, the target SN decides on the candidate target PSCell(s) to prepare among the list of PSCells to be prepared;
In step 6/7 of FIG. 1, the target SN sends to MN the CPC configuration for each prepared target PSCell and the ID of the prepared target PSCell(s).
In step 8, the MN sends to the UE a conditional (re-)configuration containing the CPC configurations of the candidate target PSCell(s) along with the CPC execution conditions;
In step 9 of FIG. 1, the UE sends a message to MN confirming the reception of the conditional configuration and MN confirms in turn to source SN the SN change preparation in step 10;
In step 11 of FIG. 1, the UE evaluates the CPC execution conditions of the prepared target PSCell(s);
In step 12 of FIG. 1, the CPC execution condition is met for e.g. a PSCell candidate in target SN 1;
The UE sends a message to MN in step 13 of FIG. 1 indicating the execution of the CPC configuration. The message includes an embedded SN RRC Reconfiguration Complete to the target SN 1 which is sent in step 14 of FIG. 1; and
The UE completes the random access in step 15 of FIG. 1.

As similarly stated above, at the time of this application with 3GPP standards the entity that initiates the CPC procedure is responsible for deciding on the list of target PSCells that may be prepared along with its corresponding CPC execution conditions. However, the target SN cannot prepare beyond maximum number of PSCells that is sent by the initiating node (Source SN). Likewise, in the SN-initiated inter-SN CPC, the source SN is responsible to set the execution condition for each target PSCell that may possibly be prepared. The CPC execution condition refers to a measurement ID in a measurement configuration that is provided by the initiating node which is the source SN in this case.

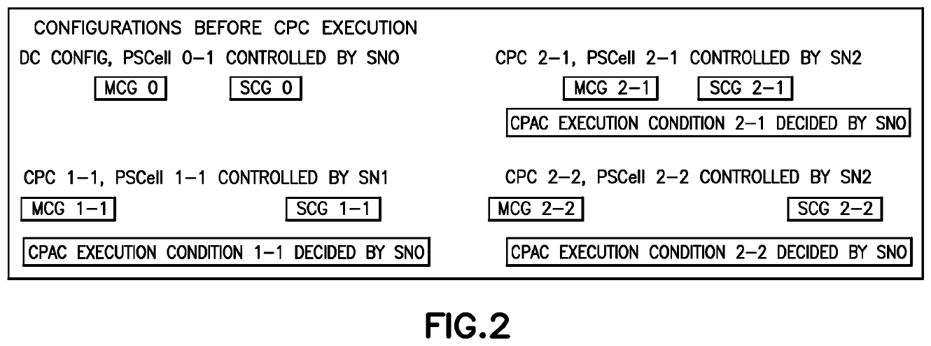

FIG. 2 shows a conditional primary cell of secondary cell group change configuration for secondary node initiated inter-SN conditional PSCell change. FIG. 2 depicts one example of the source SN preparing 3 CPCs for the UE. UE is currently being served by PSCell 0-1 (the first index 0 indicates the ID of the SN controlling PSCell, and the second index 1 indicates the ID of the PSCell in the SN, in other words PSCell 1 of SN 0 is indicated as PSCell 0-1. The RAN node controlling the serving PSCell 1 of the UE, triggers the preparation of three target PSCells each associated with a CPC configuration: CPC 1-1 configuration for prepared target PSCell 1-1 from SN1, CPC 2-1 configuration for prepared target PSCell 2-1 and CPC 2-2 configuration for PSCell 2-2, both PSCells from SN2. SN0 specifies the CPC execution condition for each prepared target cell and provides the measurement configuration to evaluate the CPC execution condition.
1) The parameters of the CPC execution condition can be set differently with respect to each prepared target cell, given that the radio conditions between the source PSCell 0-1 and prepared target PSCells can be different. For instance, the CPC 1-1 execution condition which is used by the UE to decide on the CPC execution from PSCell 0-1 to PSCell 1-1 can be different from CPC execution condition used to decide on the change from PSCell 0-1 to PSCell 2-1 or PSCell 2-2. From mobility robustness and configuration flexibility point of views, the parameters of the CPC execution conditions are configured to be specific for a source and target PSCell pair; and
2) The measurement configuration is set by SN0 in the SN-initiated conditional PSCell change procedure. Any other network node is not aware of the measurement configuration nor of the CPC execution that is set by SN0 with respect to the target PSCells.

The stage 2 specifications of inter-SN CPC standards at the time of this invention states:
“Once the CPC procedure is executed successfully, the UE releases all stored CPC configurations.”

In standards at the time of this application the UE releases all stored conditional reconfiguration after successfully executing a CPC procedure.

Mobility enhancement work item for in standards at the time of this application has the following objective, stated under objective 2:
“2. To specify mechanism and procedures of NR-DC with selective activation of the cell groups (at least for SCG) via L3 enhancements:
To allow subsequent cell group change after changing CG without reconfiguration and re-initiation of CPC/CPA [RAN2, RAN3, RAN4]”

The objective requires to change SCG without re-configuration and re-initiating of CPC/CPA preparation which implicitly indicates that the pre-configured CPC configuration should be maintained after CPC execution.

Maintaining CPC configurations after CPC execution has the following problems:

After UE executes CPC towards one of the PSCells it is configured for, UE maintains the other CPC configuration.

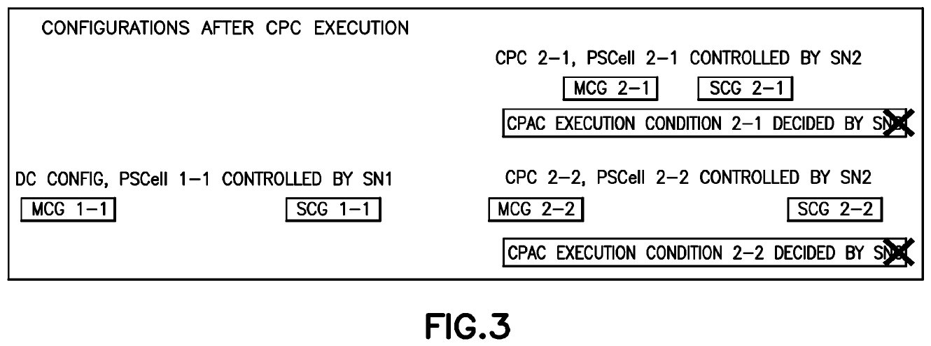

FIG. 3 shows conditional primary cell of secondary cell group change configuration for secondary node initiated inter-SN primary cell of secondary cell group after conditional primary cell of secondary cell group change execution towards primary cell of secondary cell group 1-1.

In FIG. 3, an example is illustrated where UE executes CPC towards PSCell 1-1 and SN1 becomes the serving SN for PSCell 1-1. This results in in the following issues that are summarized in the following:
In standards at the time of this application, UE cannot maintain CPC configuration after PSCell change;
SN1 is not aware of other prepared target PSCells and as such it cannot maintain the list of prepared target cells (add, release, update PSCells) or initiate early data forwarding to the right target PSCells;
One simple extension in standards at the time of this application would be if UE tries to make use of these configurations, this would require the UE to continue to evaluate the CPC executions that have been configured by previous SN 0 before the CPC execution to SN 1, i.e., the CPC execution conditions, configured by SN0, are for CPC from source PSCell 0-1 towards target PSCell 2-1 and PSCell 2-2:
   a. However, after CPC execution to SN1, these CPC execution condition that are evaluated by the UE are not necessarily convenient/optimal for deciding on the change from the new serving PSCell 1-1 (controlled by SN1) to other target PSCell 2-1 and PSCell 2-2. As a result, the robustness of CPC change might be affected and may result in failure, and
   b. Likewise, CPC conditions are tied to a measurement id that is not known by the new serving PSCell, as such the serving PSCell can reconfigure the UE and overwrite some of these measurement ids leaving the UE without any condition to trigger CPC. So a coordination of measurement IDs between involved nodes (all those whose CGs are candidates for cell change) is needed for this scheme to be operational.
      At least these two aforementioned issues are addressed in example embodiments of this invention.

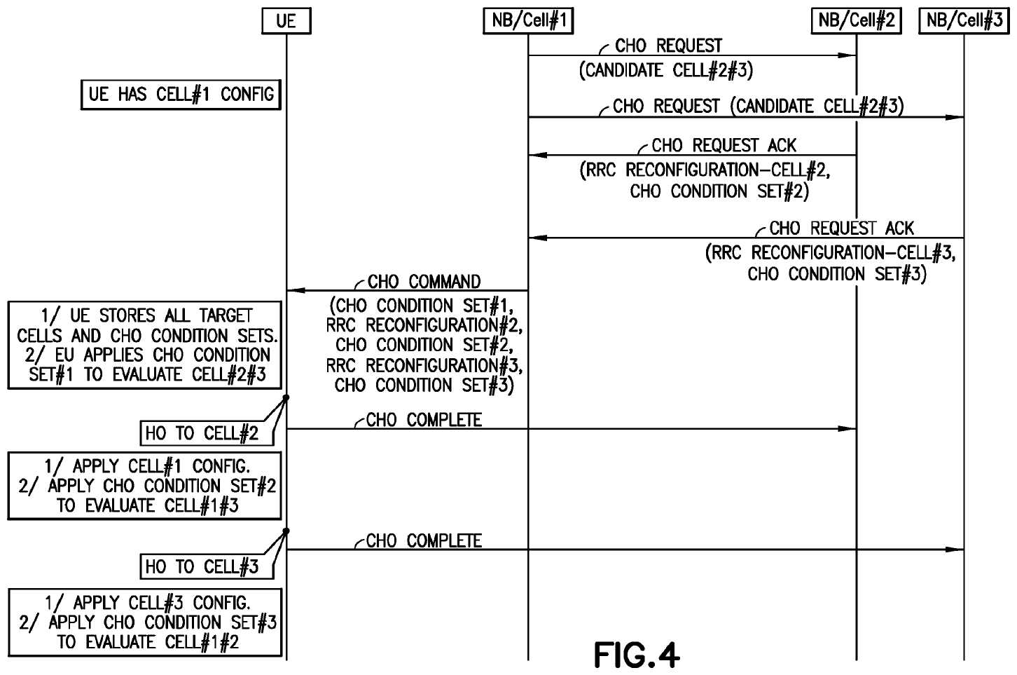

CHO is a conditional cell change for MCG. It is maintained by the source gNB or Master Node in case of dual-connectivity. A similar goal of maintaining CHO configuration after CHO execution is considered in this prior art. To achieve this, the prior art suggests that CHO Request indicates the list of candidate cells and CHO request ACK contains CHO execution condition set that is applied by the UE after performing CHO execution. For instance, as shown in FIG. 4, the UE applies CHO condition set #2 of cell 2 and set #3 of cell 3 after performing CHO to cell 2 and 3, respectively. The CHO execution condition set #2 of cell 2 contains the CHO execution conditions from cell 2 to cell 1 and from cell 2 to cell 3. The same logic applies for CHO execution condition set #3, i.e., contains the CHO execution conditions from cell 3 to cell 1 and from cell 3 to cell 2.

### Issues:

The target gNBs, controlling the prepared target cells, provides CHO execution conditions to other prepared target cells during CHO preparation which causes high signaling overhead each time a new cell is prepared by the source gNB or a prepared cell is released or replaced. This is because in each of these cases, the source gNB needs to fetch the updated CHO execution condition set from each prepared target gNB; and
This procedure is specified for CHO of MCG and cannot be applied to SCG case where SN is considered in DC

Thus, when the UE moves from the coverage area of one cell to another cell, at some point a serving cell change needs to be performed. Currently serving cell change is triggered by L3 measurements and is done by RRC signalling triggered Reconfiguration with Synchronization for change of PCell and PSCell, as well as release add for SCells when applicable. All cases involve complete L2 (and L1) resets, leading to longer latency, larger overhead and longer interruption time than beam switch mobility. The goal of L1/L2 mobility enhancements is to enable a serving cell change via L1/L2 signalling, in order to reduce the latency, overhead and interruption time.

In standards at the time of this application conditional PSCell change (CPC)/Conditional PSCell addition (CPA), a CPC/CPA-configured UE has to release the CPC/CPA configurations when completing random access towards the target PSCell. Hence the UE doesn't have a chance to perform subsequent CPC/CPA without prior CPC/CPA reconfiguration and re-initialization from the network. This will increase the delay for the cell change and increase the signaling overhead, especially in the case of frequent SCG changes when operating FR2. Therefore, MR-DC with selective activation of cell groups aims at enabling subsequent CPC/CPA after SCG change, without reconfiguration and re-initialization on the CPC/CPA preparation from the network. This results in a reduction of the signalling overhead and interrupting time for SCG change.

Further, in standards at the time of this application CHO and MR-DC cannot be configured simultaneously. This limits the usefulness of these two features when MR-DC is configured. It is submitted that future standards should specify mechanisms for CHO and MR-DC to be configured simultaneously. However, this alone may not be sufficient to optimize MR-DC mobility, as the radio link quality of the conditionally-configured PSCell may not be good enough or may not be the best candidate PSCell when the UE accesses the target PCell, and this may impact the UE throughput. To mitigate this throughput impact, Rel-18 CHO+MRDC can consider CHO including target MCG and multiple candidate SCGs for CPC/CPA.

In example embodiments of this invention, there is proposed new mechanisms enabling the UE and the network to synchronize properly and with low signalling overhead on CPC execution conditions that need to be evaluated after each CPC execution.

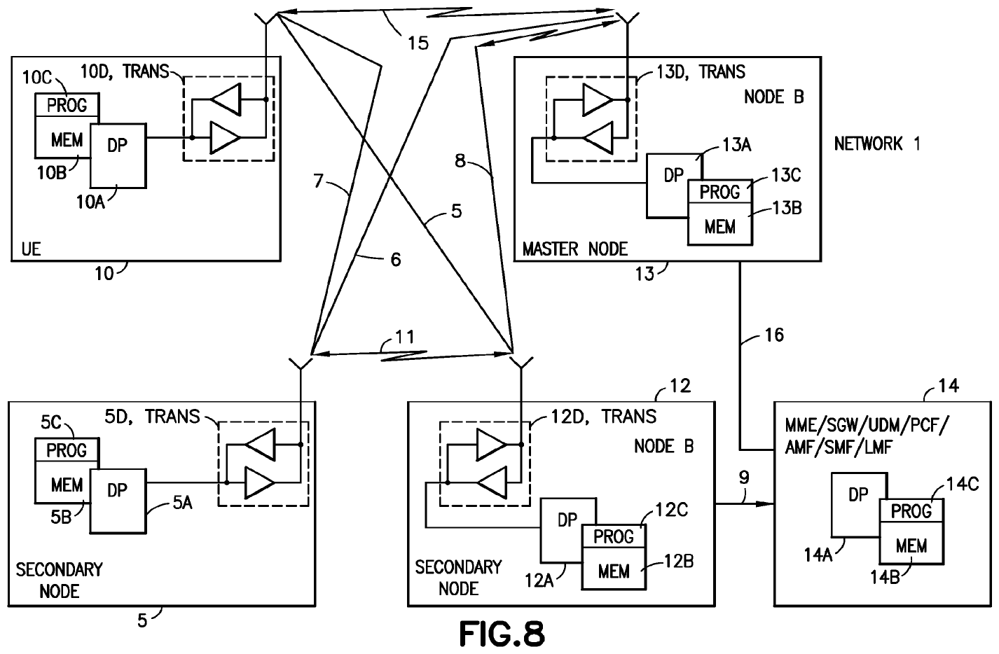

Before describing the example embodiments of the present disclosure in detail, reference is made to FIG. 8 for illustrating a simplified block diagram of various electronic devices of one possible and non-limiting exemplary system that are suitable for use in practicing the example embodiments of the present disclosure.

FIG. 8 shows a block diagram of one possible and non-limiting exemplary system in which the example embodiments of the present disclosure may be practiced. In FIG. 8, a UE, a Secondary Node, Master Node, and a Secondary Node is in wireless communication with a wireless network 1 or network 1 as in FIG. 8. It is noted that the content consumers can be user equipment type devices. The wireless network 1 or network 1 as in FIG. 8 can comprise a communication network such as a mobile network e.g., the mobile network 1 or first mobile network as disclosed herein. Any reference herein to a wireless network 1 as in FIG. 8 can be seen as a reference to any wireless network as disclosed herein. Further, the wireless network 1 as in FIG. 8 can also comprises hardwired features as may be required by a communication network. A UE is a wireless, typically mobile device that can access a wireless network. The UE, for example, may be a mobile phone (or called a “cellular” phone) and/or a computer with a mobile terminal function. For example, the UE or mobile terminal may also be a portable, pocket, handheld, computer-embedded, vehicle-mounted mobile device, or arial device and performs a language signaling and/or data exchange with the RAN.

The UE includes one or more processors DP 10A, one or more memories MEM 10B, and one or more transceivers TRANS 10D interconnected through one or more buses. Each of the one or more transceivers TRANS 10D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 10D which can be optionally connected to one or more antennas for communication to Secondary Node, Master Node, and/or Secondary Node, respectively. The one or more memories MEM 10B include computer program code PROG 10C. The UE communicates with Secondary Node, Master Node, and/or Secondary Node via a wireless link 7, 15, or 5, respectively. The one or more memories MEM 10B and the computer program code PROG 10C are configured to cause, with the one or more processors DP 10A, the UE to perform one or more of the operations as described herein.

The Secondary Node 5 includes one or more processors DP 5A, one or more memories MEM 5B, and one or more transceivers TRANS 5D interconnected through one or more buses. Each of the one or more transceivers TRANS 5D includes a receiver and a transmitter. The one or more buses may be address, data, or control buses, and may include any interconnection mechanism, such as a series of lines on a motherboard or integrated circuit, fiber optics or other optical communication equipment, and the like. The one or more transceivers TRANS 5D which can be optionally connected to one or more antennas for communication to UE, Master Node, and/or Secondary Node 12, respectively. The one or more memories MEM 5B include computer program code PROG 5C. The Secondary Node 5 communicates with UE, Master Node, and/or Secondary Node 12 via a wireless link 7, 6, or 11, respectively. The one or more memories MEM 5B and the computer program code PROG 5C are configured to cause, with the one or more processors DP 5A, the Secondary Node to perform one or more of the operations as described herein.

The Master Node is a network node that communicates with devices such as Secondary Node, Secondary Node, and/or UE of FIG. 8. The Master Node can be associated with a mobility function device such as an AMF or SMF, further the Master Node may comprise a NR/5G Node B or possibly an evolved NB, a base station such as a master or secondary node base station (e.g., for NR or LTE) that communicates with devices such as the Secondary Node and/or Secondary Node and/or UE in the wireless network 1. The Master Node includes one or more processors DP 13A, one or more memories MEM 13B, one or more network interfaces, and one or more transceivers TRANS 13D interconnected through one or more buses. In accordance with the example embodiments these network interfaces of Master Node can include X2 and/or Xn interfaces and/or other interfaces for use to perform the example embodiments of the present disclosure. Each of the one or more transceivers TRANS 13D includes a receiver and a transmitter that can optionally be connected to one or more antennas. The one or more memories MEM 13B include computer program code PROG 13C. For instance, the one or more memories MEM 13B and the computer program code PROG 13C are configured to cause, with the one or more processors DP 13A, the Master Node to perform one or more of the operations as described herein. The Master Node may communicate with the UE, Secondary Node, and/or Secondary Node or any other device using, e.g., at least link 15 and/or link 6. The link, 15, 6, or 8, respectively, as shown in FIG. 8 can be used for communication between the Master Node and UE, Secondary Node, and/or Secondary Node. It is noted that any of the link as disclosed herein can comprise one or more sidelink links. In addition, any of these links.

The Secondary Node 12 is a network node that communicates with devices such as Master Node, Secondary Node, and/or UE of FIG. 8. The Secondary Node 12 provides access to wireless devices such as the UE, Secondary Node 5, and/or Master Node to the wireless network 1. The Secondary Node 12 includes one or more processors DP 12A, one or more memories MEM 12B, and one or more transceivers TRANS 12D interconnected through one or more buses. In accordance with the example embodiments these TRANS 12D can include X2 and/or Xn and/or other interfaces for use to perform the example embodiments of the present disclosure. Each of the one or more transceivers TRANS 12D includes a receiver and a transmitter. The one or more transceivers TRANS 12D can be optionally connected to one or more antennas for communication over at least link 11 and/or link 5 and/or link 8. The TRANS 12D can connect with the Secondary Node 5 and/or UE via links 11 or link 5, respectively. The one or more memories MEM 12B and the computer program code PROG 12C are configured to cause, with the one or more processors DP 12A, the Secondary Node 12 to perform one or more of the operations as described herein. The Secondary Node 12 may communicate with another device such as the UE, Secondary Node 5, and/or Master Node such as via link 5, 11, and/or 8, respectively. Further any of the links as disclosed herein may be wired or wireless or both. Further any of the links as disclosed herein may be configured to be through other network devices such as, but not limited to an SGW/AMF/UPF device such as the MME/SGW/UDM/PCF/AMF/SMF/LMF 14 of FIG. 8. The Secondary Node 12 may perform functionalities of a Mobility Management Entity (MME), Serving Gateway (SGW), Unified Data Management (UDM), Policy Control Function (PCF), User Plane Function (UPF), Access and Mobility Management Function (AMF) and/or a Location Management function (LMF) for LTE and similar functionality for 5G.

It is noted that that the UE, Secondary Node 5, Master Node, and/or Secondary Node 12 can be configured (e.g. based on standards implementations etc.) to perform functionality of a Location Management Function (LMF). The LMF functionality may be embodied in either of the UE, Secondary Node 5, Master Node, and/or Secondary Node 12 or may be part of these network devices or other devices associated with these devices. In addition, an LMF such as the LMF of the MME/SGW/UDM/PCF/AMF/SMF/LMF 14 of FIG. 8, as at least described below, can be co-located with the UE, Secondary Node 5, Master Node, and/or Secondary Node 12 such as to be separate from the Secondary Node 5 and 12 and/or Master Node 13 of FIG. 8 for performing operations in accordance with example embodiments of the invention as disclosed herein.

These links, for instances, links 5, 6, 7, 8, 11, 15, 16, and 9 maybe wired or wireless or both and the links and/or other interfaces such as being shown in FIG. 8 or FIG. 8 may implement Xn/X2 e.g., between the UE, Secondary Node, Master Node, can include an X2/Xn interface type link. Further, as stated above any of these links may be through other network devices such as, but not limited to an MME/SGW device such as the MME/SGW/UDM/PCF/AMF/SMF/LMF 14 of FIG. 8. The MME/SGW/UDM/PCF/AMF/SMF/LMF 14 of FIG. 8 may be used to control any functions of any of the devices of the Network 1 as shown in FIG. 8.

The one or more buses of the device of FIG. 8 may be address, data, or control buses, and may include any interconnection mechanism, such as a series of lines on a motherboard or integrated circuit, fiber optics or other optical communication equipment, wireless channels, and the like. For example, the one or more transceivers TRANS 12D, TRANS 13D, TRANS 5D, and/or TRANS 10D may be implemented as a remote radio head (RRH), with the other elements of the UE, Secondary Node, Master Node, and/or Secondary Node being physically in a different location from the RRH, and one or more buses could be implemented in part as fiber optic cable to connect the other elements of the UE, Secondary Node, Master Node, and/or Secondary Node to a RRH for example.

It is noted that although FIG. 8 shows a network nodes Such as UE, Secondary Node, Master Node, and/or Secondary Node. Any of these nodes can communicate with an eNodeB or eNB or gNB such as for LTE and NR, and would still be configurable to perform example embodiments of the present disclosure.

Also it is noted that description herein indicates that “cells” perform functions, but it should be clear that the gNB that forms the cell and/or a user equipment and/or mobility management function device that will perform the functions. In addition, the cell makes up part of a gNB, and there can be multiple cells per gNB.

The wireless network 1 or any network it can represent may or may not include a MME/SGW/UDM/PCF/AMF/SMF/LMF 14 that may include Mobility Management Entity (MME), and/or Serving Gateway (SGW), and/or Unified Data Management (UDM), and/or Policy Control Function (PCF), and/or Access and Mobility Management Function (AMF), and/or Session Management Function (SMF), and/or Authentication Server Function (AUSF) and/or Location Management Function (LMF) and which provides connectivity with a further network, such as a telephone network and/or a data communications network (e.g., the Internet), and which is configured to perform any 5G and/or NR operations in addition to or instead of other standards operations at the time of this application. The MME/SGW/UDM/PCF/AMF/SMF/LMF 14 is configurable to perform operations in accordance with example embodiments of the present disclosure in any of an LTE, NR, 5G and/or any standards based communication technologies being performed or discussed at the time of this application. In addition, it is noted that the operations in accordance with example embodiments of the present disclosure, as performed by the Secondary Node and/or Master Node, may also be performed at the MME/SGW/UDM/PCF/AMF/SMF/LMF 14.

Regarding the LMF functionality of the MME/SGW/UDM/PCF/AMF/SMF/LMF 14 of FIG. 8, the LMF receives measurements and assistance information from the communication network and user equipment (UE). This can be via an Access and Mobility Management Function (AMF) over an interface to determine a position of the UE. The Secondary Node and/or the UE as in FIG. 8 may communicate with the LMF via at least any of links 5, 6, 11, and/or 15. The Secondary Node can if necessary then further communicate with the LMF of the MME/SGW/UDM/PCF/AMF/SMF/LMF 14 of FIG. 8 via the link 9 as in FIG. 8.

It is noted that the link 16 or link 9 can connect to any links needed between Secondary Node, UE, Secondary Node, and/or Master Node and the MME/SGW/UDM/PCF/AMF/SMF/LMF 14 of FIG. 8 for any of these devices to communicate with at least the LMF of the MME/SGW/UDM/PCF/AMF/SMF/LMF 14 of FIG. 8. Further, it is noted that any of links that are mentioned in this paper can include hardwired links and/or wireless links and, as needed, and/or include any type of interface (e.g., LTE and/or 5G interface) such as but not limited to at least one of an Xn, X2, S1, NG, NG-C, NLs, E1, and/or F1 type interface.

The MME/SGW/UDM/PCF/AMF/SMF/LMF 14 includes one or more processors DP 14A, one or more memories MEM 14B, and one or more network interfaces (N/W I/F(s)), interconnected through one or more buses coupled with at least links 16 and 9. Communication between the Secondary Node or Master Node and the LMF may be performed via an Access and Mobility Management function (AMF) e.g., of the MME/SGW/UDM/PCF/AMF/SMF/LMF 14. A control plane interface between Secondary Node and/or Master Node (or a gNB) and AMF can be an NG-C interface and an interface between the AMF and LMF can be NLs. In accordance with the example embodiments these network interfaces can include X2 and/or Xn and/or other interfaces for use to perform the example embodiments of the present disclosure. The one or more memories MEM 14B include computer program code PROG 14C. The one or more memories MEM 14B and the computer program code PROG 14C are configured to, with the one or more processors DP 14A, cause the MME/SGW/UDM/PCF/AMF/SMF/LMF 14 to perform or work with the Secondary Node or Master Node to perform one or more operations which may be needed to support the operations in accordance with the example embodiments of the present disclosure.

The wireless Network 1 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors DP10, DP12A, DP13A, DP5A, and/or DP14A and memories MEM 10B, MEM 12B, MEM 13B, MEM 5B, and/or MEM 14B, and also such virtualized entities create technical effects.

The computer readable memories MEM 12B, MEM 13B, MEM 5B, and MEM 14B may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories MEM 12B, MEM 13B, MEM 5B, and MEM 14B may be means for performing storage functions. The processors DP10, DP12A, DP13A, DP5A, and DP14A may be of any type suitable to the local technical environment, and may include one or more of general purpose computers, special purpose computers, microprocessors, digital signal processors (DSPs) and processors based on a multi-core processor architecture, as non-limiting examples. The processors DP10, DP12A, DP13A, DP5A, and DP14A may be means for performing functions, such as controlling the UE, Secondary Node, Secondary Node, Master Node, and other functions as described herein.

In general, various embodiments of the Secondary Node and/or UE can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Further, the various embodiments of Secondary Node or UE can be used with a UE vehicle, a High Altitude Platform Station, or any other such type node associated with a terrestrial network or any drone type radio or a radio in aircraft or other airborne vehicle.

As similarly stated above, in example embodiments of this invention, there is proposed new mechanisms enabling the UE and the network to synchronize properly and with low signalling overhead on CPC execution conditions that need to be evaluated after each CPC execution.

Embodiment 1: After Inter-SN CPC execution, the MN indicates to the new SN the list of prepared PSCells for the UE. The new SN can use this information to configure CPC execution condition for each prepared PSCell:
Optionally, the new SN may indicate the successful execution of PSCell change. As such, the MN can use this information to provide the UE with the updated CPC execution conditions that are received from new SN, i.e., the CPC execution conditions are not provided to the UE before it is ensured that the CPC execution is successfully completed;
Optionally, the SN may indicate new CPAC incoming probabilities to MN, i.e., the probability that the UE execute a CPAC to each of the prepared PSCell MN forwards this information to other prepared target PSCells/nodes such that they can adjust their resource reservation (perform overbooking), if needed;

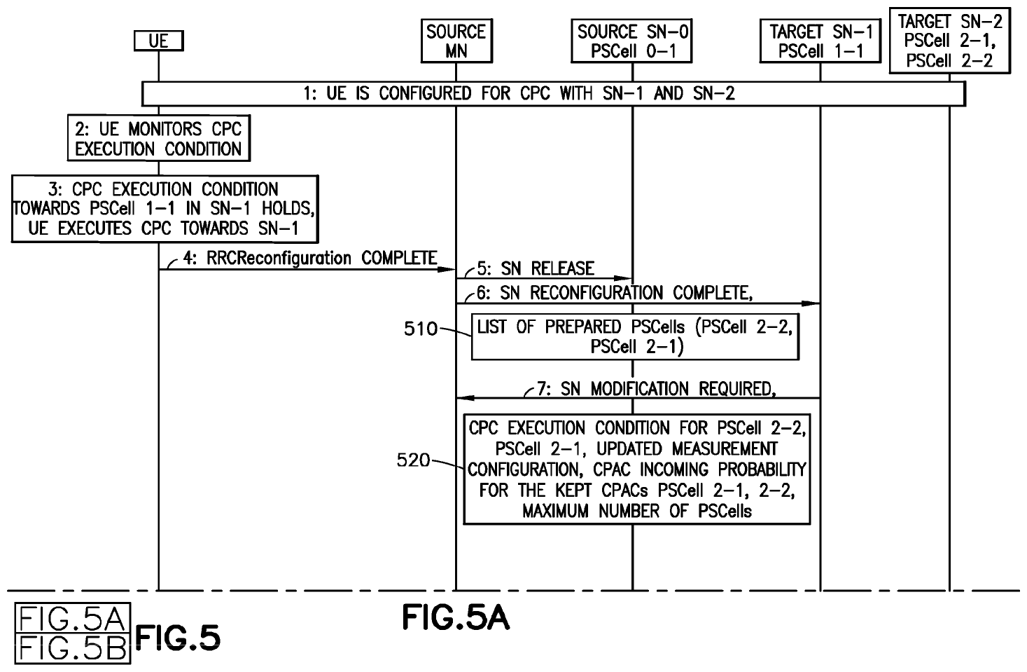

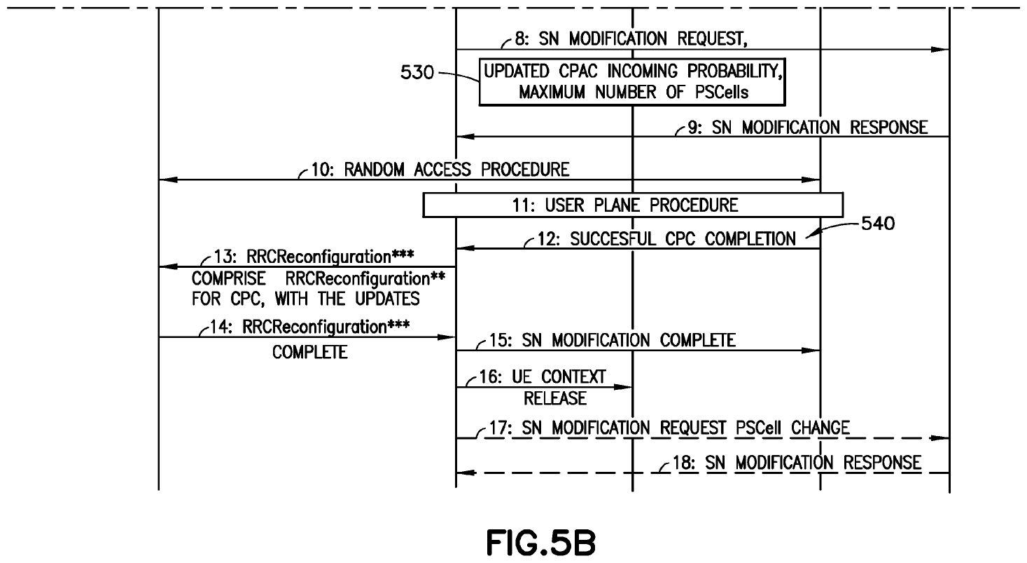

FIG. 5 shows a message sequence chart for embodiment 1 in accordance with example embodiments of the invention. Novel features in accordance with example embodiments of the invention are, in particular, shown in steps 510, 520, 530, and 540 of FIG. 5.

The steps of FIG. 5 are described below. Note at least the underlined steps below are in accordance with example embodiments of the invention.

As shown in FIG. 5:
Step 1: UE is configured with CPC through the SN-initiated inter-SN PSCell change procedure;
Step 2: UE monitors the CPC execution conditions as configured in the conditional configurations;
Step 3-4-5: if the CPC execution condition for PSCell 1-1 holds, the UE initiates execution of the cell change from serving cell PSCell 0-1 of source SN-0 to target cell PSCell 1-1 of target SN-1, and sends related RRCReconfiguration complete including indication of cell change to the serving source MN:
   MN indicates SN change from the serving PSCell 0-1 of SN-0 and sends related SN release message to SN-0 to release the connection of the UE with the PSCell 0-1 of SN-0 to;
Step 6: MN sends a RRCReconfiguration complete message to the target SN1 to prepare CPC execution conditions for cell changes from PSCell 1-1 to other cells. The other cells may include PSCells 2-1 and 2-2. Those 2 cells have already been prepared for cell change from PSCell 0-1 to PSCell 2-1 or 2-2, and thus may be reused or also used for a potential cell change from PSCell 1-1 to PSCells 2-1 or 2-2:
   MN indicates the list of prepared PSCells to target SN-1:
      PSCell 2-1, PSCell 2-2, MN may optionally also include PSCell 0-1. As UE will be connected to PSCell 1-1 (cell change from PSCell 0-1), a CPC execution condition for a cell change from PSCell 1-1 to PSCell 0-1 could be configured.
      In one alternative the Meas IDs used for CPC execution is indicated to the new serving SN;
Step 7: Target SN-1 checks whether PSCells 2-1 and 2-2 could be configured for the UE (e.g. depending on further criteria, e.g. load conditions, etc.) and then configures a corresponding set of updated execution condition for at least one or each prepared PSCell and related measurement configuration:
   MN may send an RRCReconfiguration message with the updated CPC configuration to the UE (step 13), or alternatively the SN-1 may send an RRCReconfiguration message with the updated CPC configuration to the UE (e.g. after step 10, after completion of random access procedure between UE and PSCell 1-1);
Step 8-9 MN sends SN modification to SN-2 and informs SN_2 e.g. about updated CPAC incoming probabilities and maximum number of PSCells.
Step 10: UE initiates random access procedure for establishing connection towards the target PSCell (PSCell 1-1);
Step 11: The user plane procedure includes e.g. the transfer of data packets from MN to SN-1 to be forwarded to the UE.
Step 12: Target SN-1 indicates the successful completion of the PSCell change procedure to MN:
   MN may use this message as a trigger to send the RRCReconfiguration with the CPC execution condition and measurement configuration that are received from target SN-1 in step 7 to the UE,
   In case UE fails to access PSCell 1-1 during the PSCell change procedure, the UE would have received unnecessarily an updated configuration, configured by a SN that it is not connected to,
   As such, sending the CPC execution condition and updated measurement configuration after successful completion of the random access to the target PSCell can be beneficial. This version is used in Step 11;
Step 13-14-16:
   UE is configured by the MN through RRCReconfiguration and sends RRCReconfiguration complete after successful application of the configuration,
   MN releases the UE context from the last serving SN;
Step 15-17-18 SN modification messages to update SN-1 and SN-2.
Further:
   The new SN controlling the new serving PSCell of the UE, e.g. SN-1 (controlling PSCell 1-1 towards which UE changed from previously serving PSCell 0-1 of SN-0) informs the MN about the CPAC incoming probabilities for at least one of the prepared target PSCell 2-1 and/or 2-2. In addition, the maximum number of PSCells supported could be provided,
   MN indicates the CPAC incoming probabilities to the SNs of the prepared cells, e.g. SN-2, and optionally also the maximum number of PSCells
   In one embodiment, this can be performed together with step 7 and 8.

Embodiment 2: During SN addition request, MN indicates to the target SN the list of already other prepared PSCells. The target SN make use of this list to provide a measurement configuration and execution condition for each other prepared PSCell such that, UE would be able to switch from PSCell of the target SN to the one of the other prepared PSCells that are indicated by MN to target SN:
MN sends a new SN modification request to target SN controlling a prepared PSCell, after addition of a new PSCell in other target node. In this modification request, MN indicates the list of newly added PSCell(s) to the target SN such that the target SN provides a measurement configuration and execution condition for each newly added other target PSCell(s);
MN sends new SN modification request to target SN controlling a prepared PSCell, after release of an already prepared PSCell in other target node. In this modification request, MN indicates the list of prepared target PSCells that are released such that the target SN can provide an updated measurement configuration, e.g., basically releasing the measurement ID corresponding to the CPC execution condition of the PSCell that is released; and
Optionally, the SN may indicate multiple CPAC incoming probabilities to MN. Each CPAC incoming probability is related to a cell pair, PSCell prepared by SN versus each already prepared PSCell. MN can use this information to indicate to target PSCells such that they can adjust their resource reservation
Source MN informs target SN about other PSCells that are to be prepared and which are controlled by another target MN

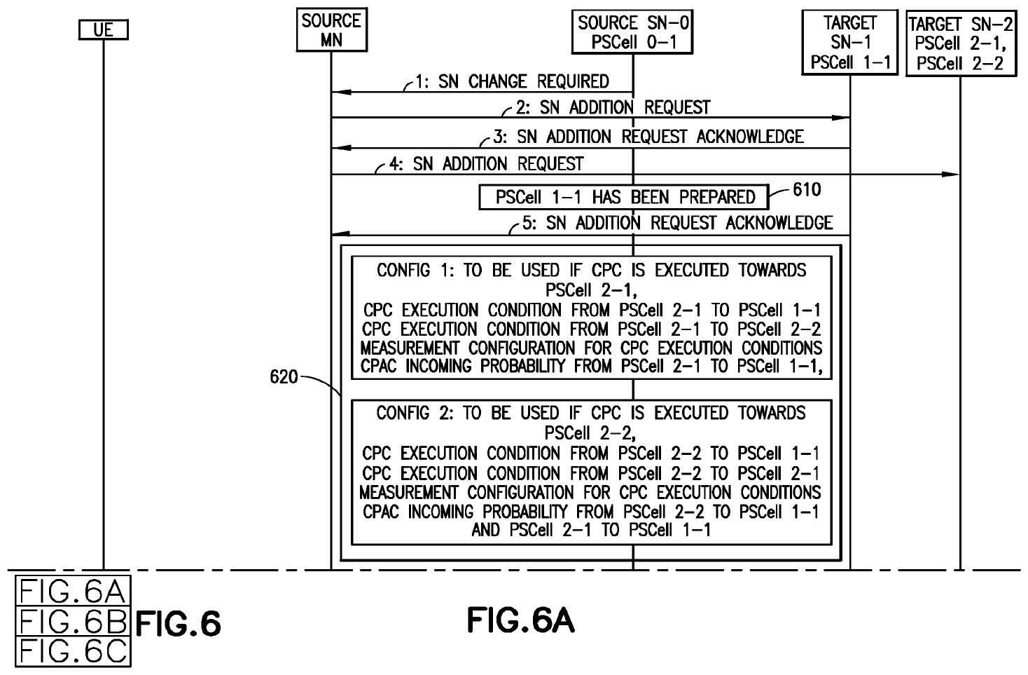

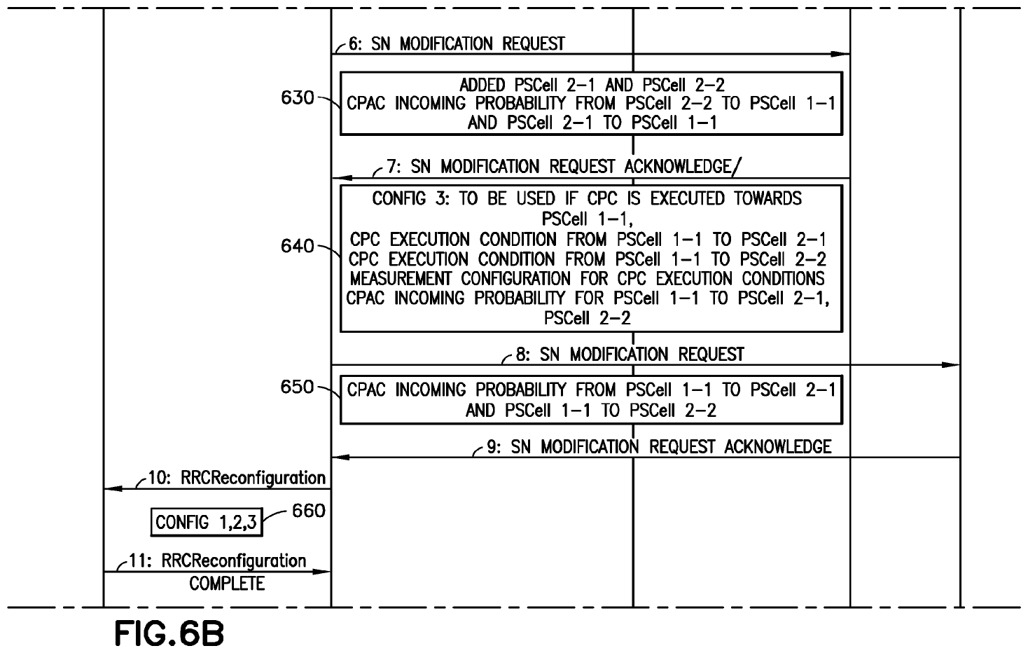

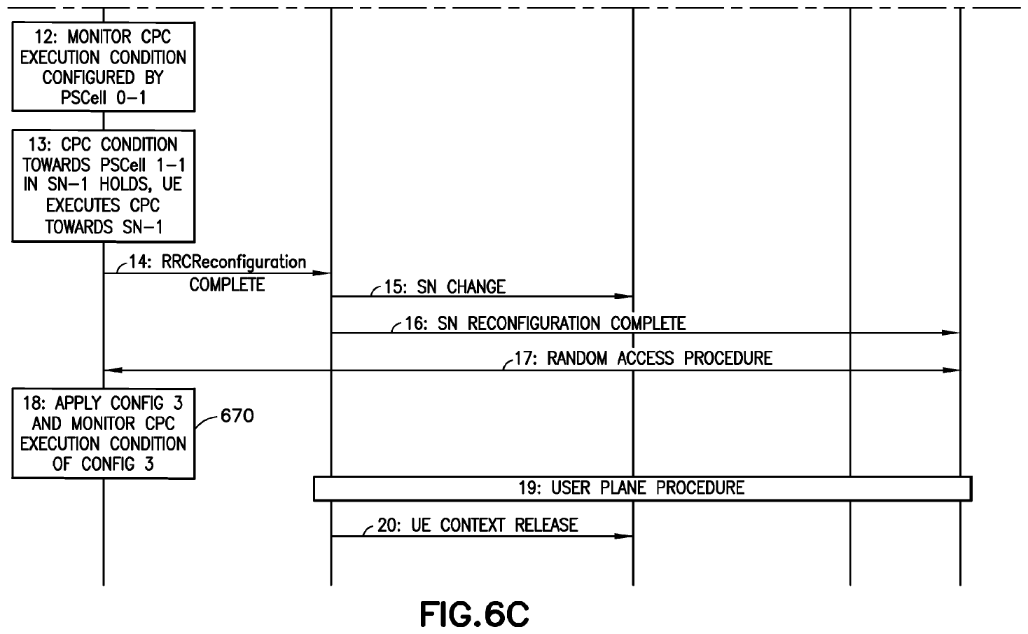

FIG. 6 shows a message sequence chart for embodiment 2 in accordance with example embodiments of the invention. Novel features in accordance with example embodiments of the invention are, in particular, shown in steps 610, 620, 630, 640, 650, 660, and 670 of FIG. 6.

The steps of FIG. 6 are described below. Note at least the underlined steps below are in accordance with example embodiments of the invention.

As shown in FIG. 6:
Step 0: Through UE measurements, SN-0 (including the PSCell 0-1 currently serving the UE, the UE being in dual connected mode with a serving MN and a serving SN-0 for the second link) determines that a PSCell change is needed;
Step 1: SN-0 indicates to MN, that PSCell change is needed, and adds a list of candidate PSCells, it also includes a CPC execution condition for each candidate PSCell and measurement configuration;
Step 2-3: MN sends SN addition request to SN-1 for CPC preparation of PSCell 1-1:
   SN-1 checks if PSCell 1-1 could be prepared (e.g. in view of other criteria like load conditions, etc.) and if so, prepares the configuration and sends it with SN addition response;
Step 4-5: MN sends SN addition request for CPC of PSCell 2-1 and PSCell 2-2 to SN-2:
   MN indicates that PSCell 1-1 (from target SN-1) is already prepared for CPC for the UE:
      In one alternative the Meas IDs used for CPC execution is indicated to the target SNs;
   SN-2 prepares the configuration for at least one or each PSCell 2-1 and 2-2;
   SN-2 prepares an additional configuration for each PSCell 2-1 and PSCell 2-2 it prepares:
      In config 1 for PSCell 2-1 it adds:
         CPC execution condition from PSCell 2-1 to PSCell 1-1.
         CPC execution condition from PSCell 2-1 to PSCell 2-2,
         Measurement configuration containing the configuration of the CPC execution conditions.
         CPAC Incoming probability from PSCell 2-1 to PSCell 1-1;
         Config 1 is prepared for the following case: if CPC is executed from PSCell 0-1 towards PSCell 2-1, and UE is then connected to new serving cell PSCell 2-1, then UE is already prepared with CPC execution condition for a potential cell change in case of bad radio conditions from new serving cell PSCell 2-1 towards PSCell 1-1 or PSCell 2-2.
         In addition, config 1 may include CPC execution condition for a potential cell change in case of bad radio conditions from new serving cell PSCell 2-1 towards PSCell 0-1.
      In config 2 for PSCell 2-2 it adds:
         CPC execution condition from PSCell 2-2 to PSCell 1-1,
         CPC execution condition from PSCell 2-2 to PSCell 2-1,
         Measurement configuration containing the configuration of the CPC execution conditions,
         CPAC Incoming probability from PSCell 2-2 to PSCell 1-1,
         Config 2 is prepared for the following case: if CPC is executed from PSCell 0-1 towards PSCell 2-2, and UE is then connected to new serving cell PSCell 2-2, then UE is already prepared with CPC execution condition for a potential cell change in case of bad radio conditions from new serving cell PSCell 2-2 towards PSCell 1-1 or PSCell 2-1.
         In addition, config 1 may include CPC execution condition for a potential cell change in case of bad radio conditions from new serving cell PSCell 2-2 towards PSCell 0-1.
   SN-2 sends the configurations with SN addition response to MN;
Step 6-7: MN sends SN modification request for target SN-1 controlling prepared PSCell 1-1:
   MN indicates that PSCell 2-1 and PSCell 2-2 is prepared for CPC for the UE:
      MN optionally indicates the CPAC Incoming probabilities from PSCell 2-1 to PSCell 1-1 and from PSCell 2-2 to PSCell 1-1,
   SN-1 prepares an additional configuration for PSCell 1-1:
      In config 3 for PSCell 1-1 it adds:
         CPC execution condition from PSCell 1-1 to PSCell 2-1,
         CPC execution condition from PSCell 1-1 to PSCell 2-2,
         Measurement configuration containing the configuration of the CPC execution conditions,
         CPAC Incoming probability from PSCell 1-1 to PSCell 2-1 and from PSCell 1-1 to PSCell 2-2;
         Config 3 is prepared for the following case: if CPC is executed from PSCell 0-1 towards PSCell 1-1, and UE is then connected to new serving cell PSCell 1-1, then UE is already prepared with CPC execution condition for a potential cell change in case of bad radio conditions from new serving cell PSCell 1-1 towards PSCell 2-1 or PSCell 2-2.
         In addition, config 1 may include CPC execution condition for a potential cell change in case of bad radio conditions from new serving cell PSCell 1-1 towards PSCell 0-1.
   SN-1 sends the configurations with SN addition response to MN;
Step 8-9: MN indicate the incoming probabilities from PSCell 1-1 to PSCells 2-2 and PSCell 2-1;
Step 10-11-12: MN forwards the RRCReconfiguration comprising the CPC configurations (Config 1, 2, 3) to the UE:
   UE indicates the successful configuration with RRCReconfigurationComplete message to MN,
   UE monitors the CPC execution conditions provided by SN-0:
Step 13-14-15-17:
   After some time, if the CPC execution condition PSCell 0-1 towards PSCell 1-1 holds,
   UE executes CPC and sends RRCReconfiguration complete to the MN,
   MN indicates SN change to the serving SN-0 (serving PSCell 0-1),
   MN sends the RRCReconfiguration complete to the new SN-1,
   UE initiates random access procedure for establishing connection and towards the target PSCell (PSCell 1-1);
Step 18: UE uses config 3 to monitor CPC execution condition from PSCell 1-1 to other prepared target PSCells 2-1 and 2-2.
The CPC configurations (Config 1, 2, 3) are sent to the UE e.g. in step 10, thus in particular before the random access procedure (step 17) is performed, and also before the first execution condition holds (step 13). This is advantageously as the UE is this way pre-configured with concatenated or cascaded CPCs: UE receives a first kind of CPC config CPC1 for e.g. switch from SN-0 to SN-1 and SN-0 to SN-2 and a second kind of CPC config CPC2 (config 1,2,3) for e.g. switch of SN-1 to SN-2 after switch from SN-0 to SN1 and for switch of SN-2 to SN-1 after switch from SN-0 to SN2. In case CPC1 execution condition holds and UE changes cell, UE is enabled to, directly after cell change, monitor CPC2. This increases mobility robustness and leads to less radio link failures.

Embodiment 3: For SN-initiated PSCell change, the source SN triggers the preparation of conditional PSCell change without providing a CPC execution condition:
In one aspect (embodiment 3-1), source SN receiving measurements from the UE may decide to trigger the change to one of the prepared target PSCells. Herein, (a particular novel aspect) source SN informs the MN about the Global or Physical Cell Identity (PCI) of the prepared target PSCell to which the change should occur. Having received the PCI from the source SN, MN can send an RRC Reconfiguration (or a command) instructing the UE to execute the conditional reconfiguration (identified by a specific ID that is decided by MN) associated with the indicated PCI; or.
Alternatively (embodiment 3-2), MN shares with source SN the ID of the conditional reconfigurations that are associated with the prepared target PSCells. Upon receiving the measurements from the UE, the source SN can send now an SN RRC Reconfiguration (or a command) instructing the UE to execute the conditional reconfiguration (identified by an ID) of a specific target PSCell.

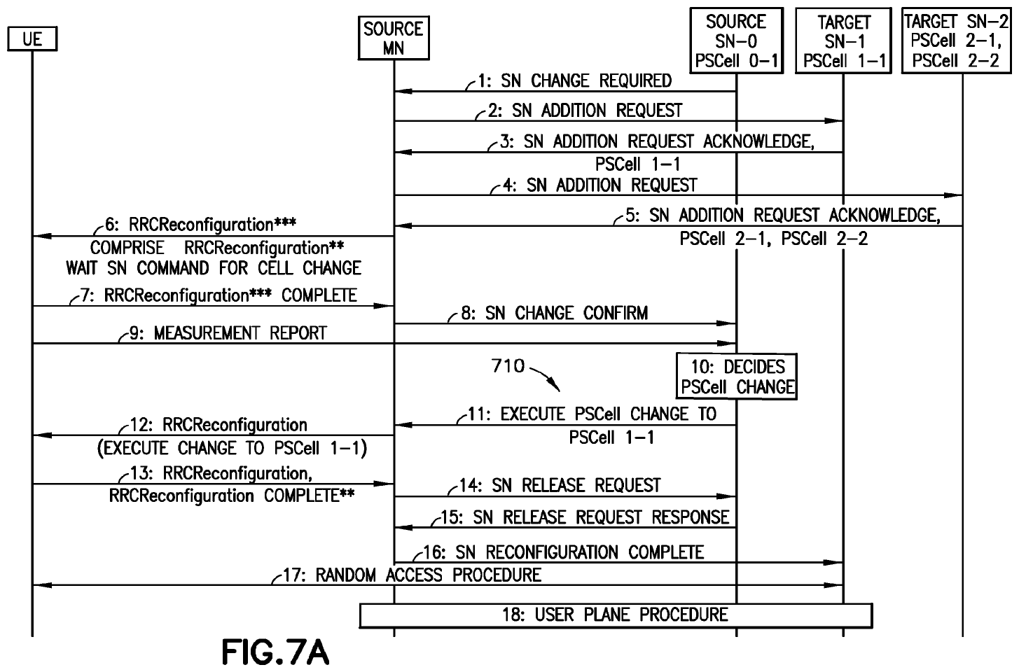

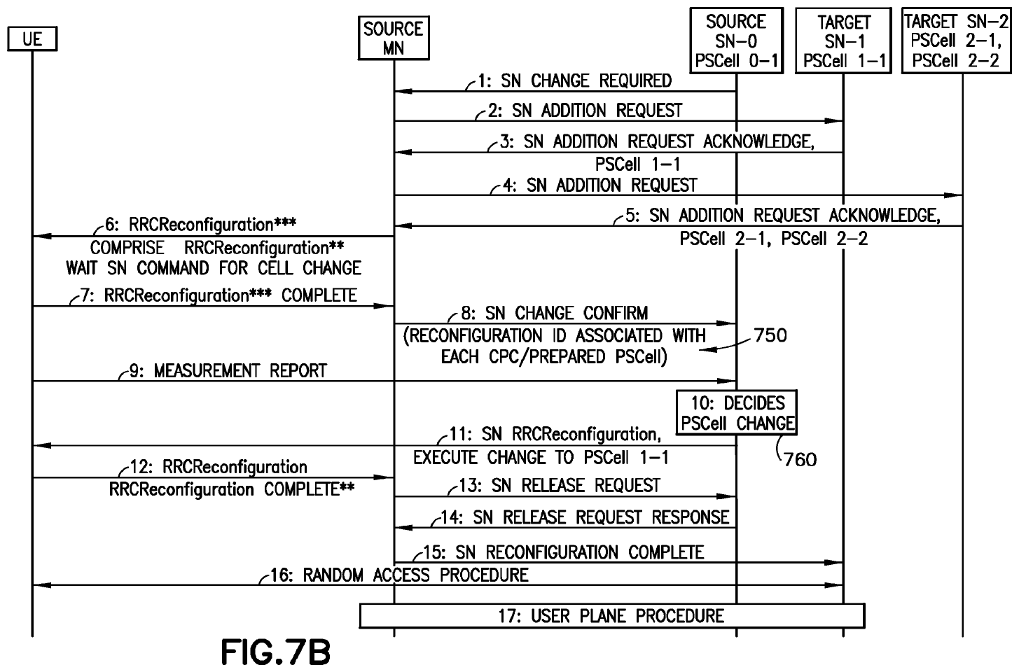

FIG. 7A shows a message sequence chart for embodiment 3 alternative 1 in accordance with example embodiments of the invention. Novel features in accordance with example embodiments of the invention are, in particular, shown in step 710 of FIG. 7.

The steps of FIG. 7A are described below. Note at least the underlined steps below are in accordance with example embodiments of the invention.

As shown in FIG. 7A:
Step 0: Through UE measurements, SN determines that a PSCell change is needed;
Step 1: SN indicates to MN, that PSCell change is needed, and adds a list of candidate PSCells it also includes execution condition and measurement configuration for each candidate PSCell;
Step 2-3: MN sends SN addition request to SN-1 for CPC of PSCell 1-1:
   SN-1 prepares the configuration and sends this with SN addition response;
Step 4-5: MN sends SN addition request to SN-2 for CPC of PSCell 2-1 and PSCell 2-2:
   SN-2 prepares the configuration and sends this with SN addition response;
Step 6-7: MN forwards the RRCReconfiguration comprising the CPC configurations to the UE:
   MN indicates to the UE that UE has to wait for MN command to execute PSCell change,
   UE indicates the successful configuration with RRCReconfigurationComplete message to MN;
Step 8: With SN change confirm, MN indicates to source SN s the RRCReconfiguration id for CPC preparations;
Step 9: UE sends a measurement report to the serving SN (e.g. directly if a control connection between UE and serving SN exists, or indirectly, e.g. measurement report is sent to MN and at least partly forwarded to serving SN);
Step 10: SN determines, e.g. based on measurement report, PSCell change is necessary and decides to which PSCell to switch to, e.g. PSCell 1-1;
Step 11-12: As for option 1: Source SN indicates to source MN the PSCell id, to which UE should execute PSCell change.
   Step 12: Source MN indicates the PSCell id to the UE, and optionally includes e.g. Cond.ConfwithSync ID to the UE related to the PSCell indicated by the Source SN;
Step 13-14-15-16-17-18:
   UE sends RRCReconfiguration complete to the MN,
   MN sends SN release request to the serving SN-0,
   Serving SN acknowledges the release request,
   MN sends the RRCReconfiguration complete to the new SN-1,
   UE initiates random access procedure for establishing connection towards the target PSCell (PSCell 1-1),
   User plane procedures are completed to update the data forwarding, e.g. from MN to new SN-1 to forward data to UE.

FIG. 7B shows a message sequence chart for embodiment 3 alternative 2 in accordance with example embodiments of the invention. Novel features in accordance with example embodiments of the invention are, in particular, shown at least in step 750 and 760 of FIG. 7B.

The steps of FIG. 7B are described below. Note at least the underlined steps below are in accordance with example embodiments of the invention.

As shown in FIG. 7B:
Step 0: Through UE measurements, SN determines that a PSCell change is needed;
Step 1: SN indicates to MN, that PSCell change is needed, and adds a list of candidate PSCells, it also includes execution condition and measurement configuration for each candidate PSCell.
Step 2-3: MN sends SN addition request to SN-1 for CPC of PSCell 1-1:
   SN-1 prepares the configuration and sends this with SN addition response.
Step 4-5: MN sends SN addition request to SN-2 for CPC of PSCell 2-1 and PSCell 2-2.
   SN-2 prepares the configuration and sends this with SN addition response;
Step 6-7: MN forwards the RRCReconfiguration comprising the CPC configurations to the UE:
   MN indicates to the UE that UE has to wait for SN command to execute PSCell change, and provides a reconfiguration id and/or a CPC id for each prepared PScell, the id(s) being used to identify the PSCell to switch/change to in case cell change is needed and instructed,
   UE indicates the successful configuration with RRCReconfigurationComplete message to MN;
Step 8: With SN change confirm, MN indicates to source SNs the RRCReconfiguration id and or CPC ids for the prepared PSCells;
Step 9: UE sends a measurement report to the serving SN;
Step 10: SN determines PSCell change is necessary;
Step 11: SN triggers PSCell change to PSCell 1-1 with RRCReconfiguration, indicating UE should use the existing CPC, with the reconfiguration id and/or CPC id communicated to serving SN by the serving MN;
Step 12-13-14-15-16-17:
   UE executes sends RRCReconfiguration complete to the MN,
   MN sends SN release request to the serving SN0,
   Serving SN acknowledges the release request,
   MN sends the RRCReconfiguration complete to the new SN,
   UE initiates random access procedure and completes RRCReconfiguration towards the target PSCell (PSCell 1-1).

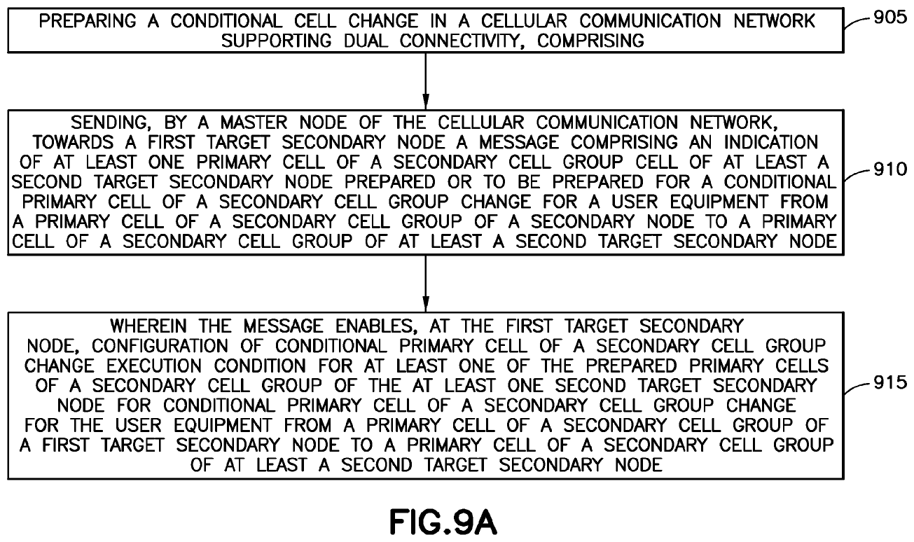

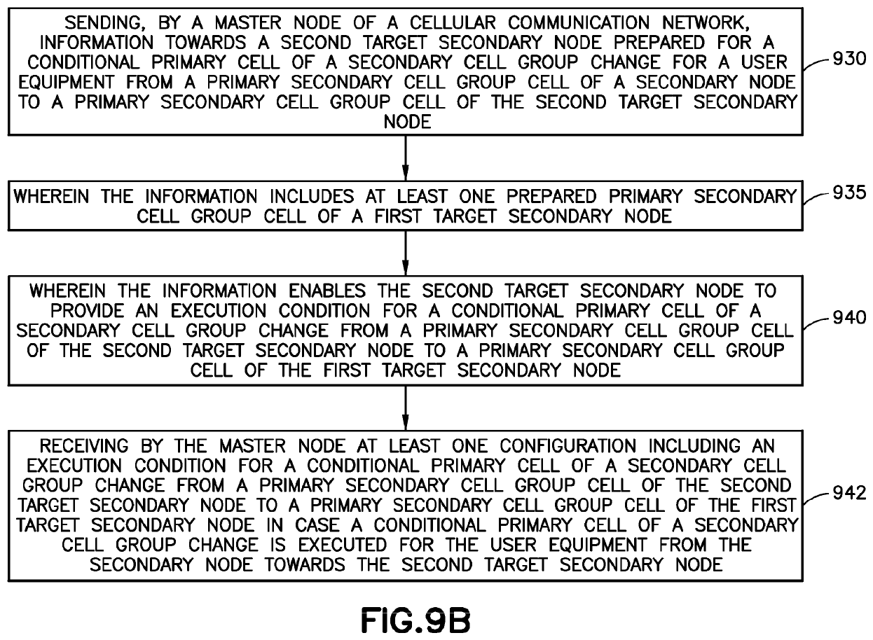

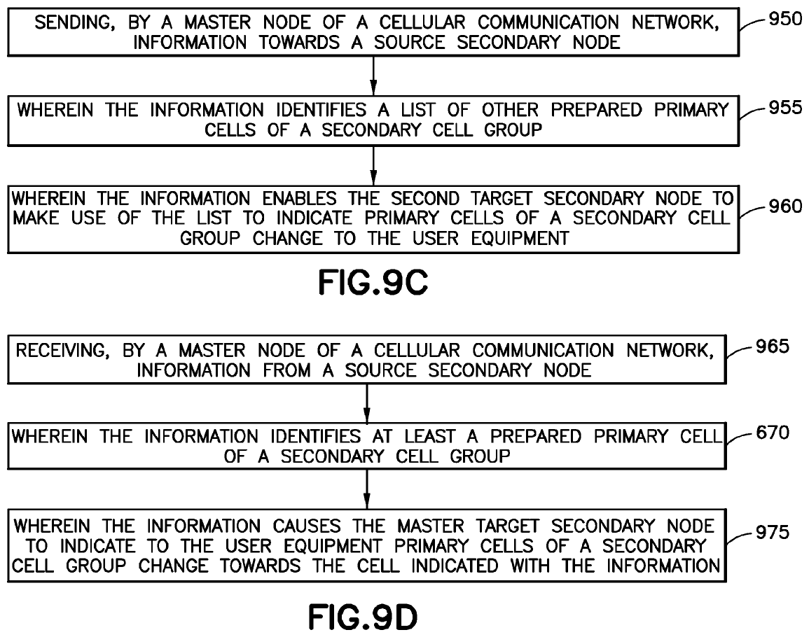

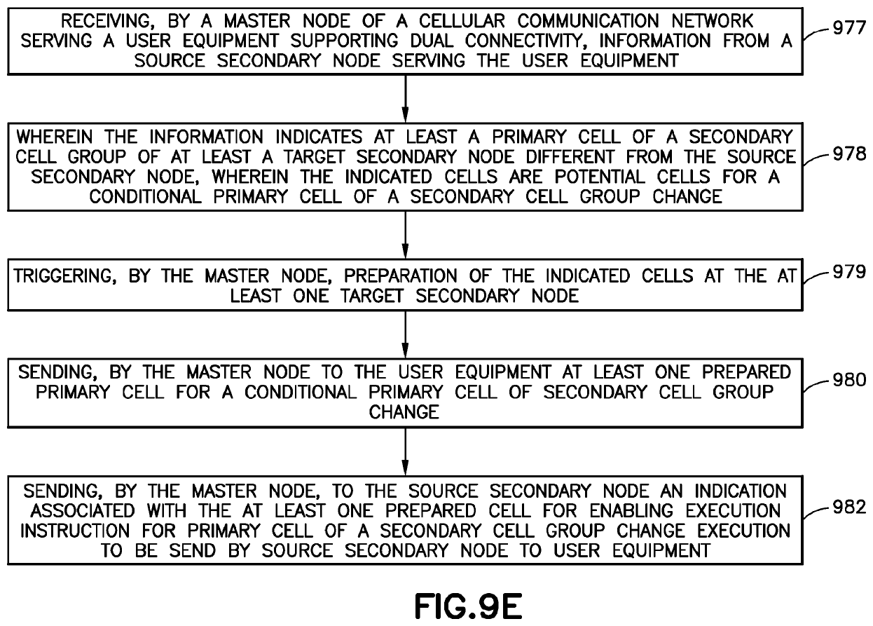

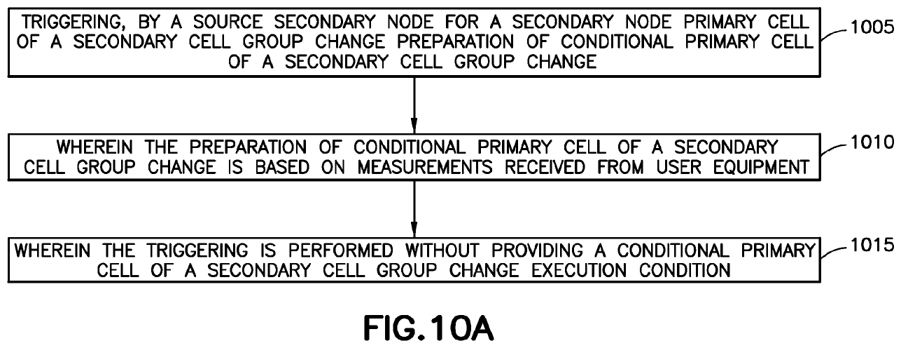

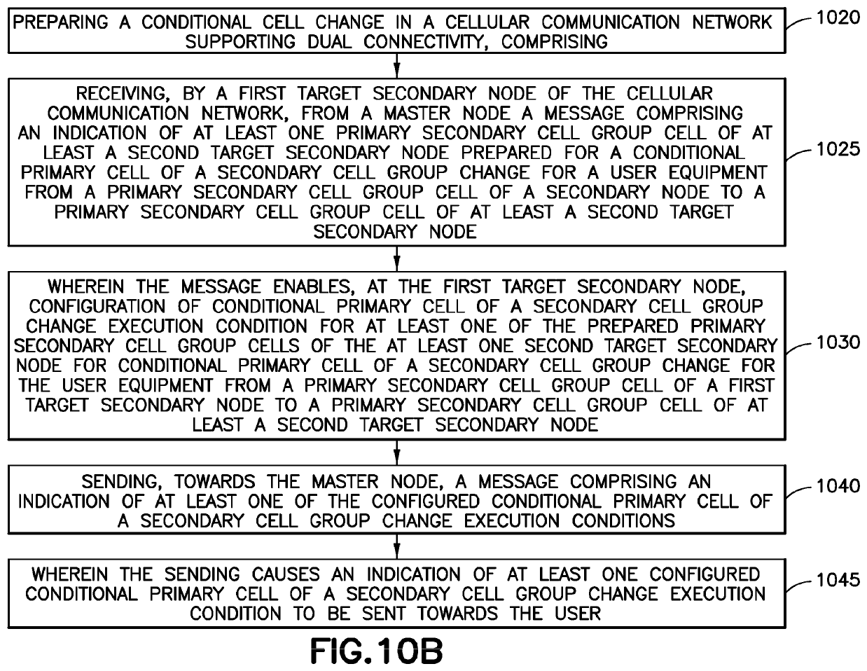

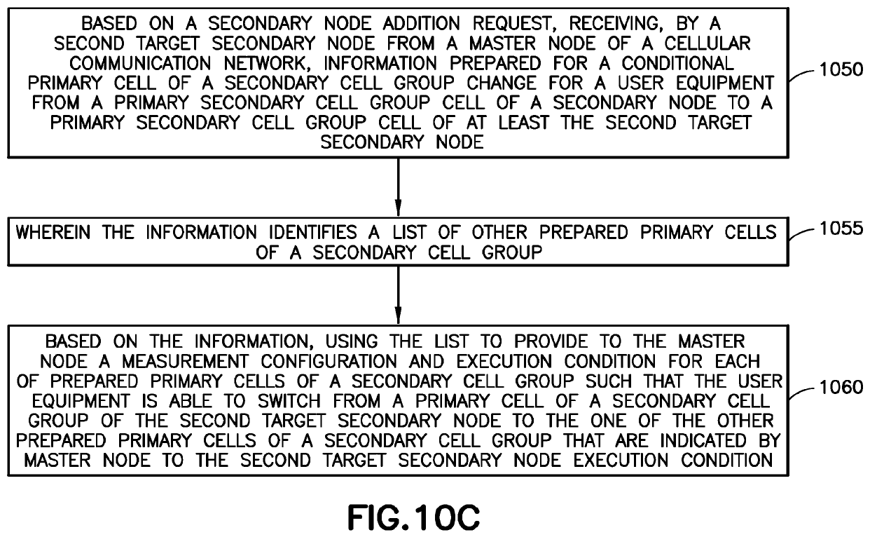

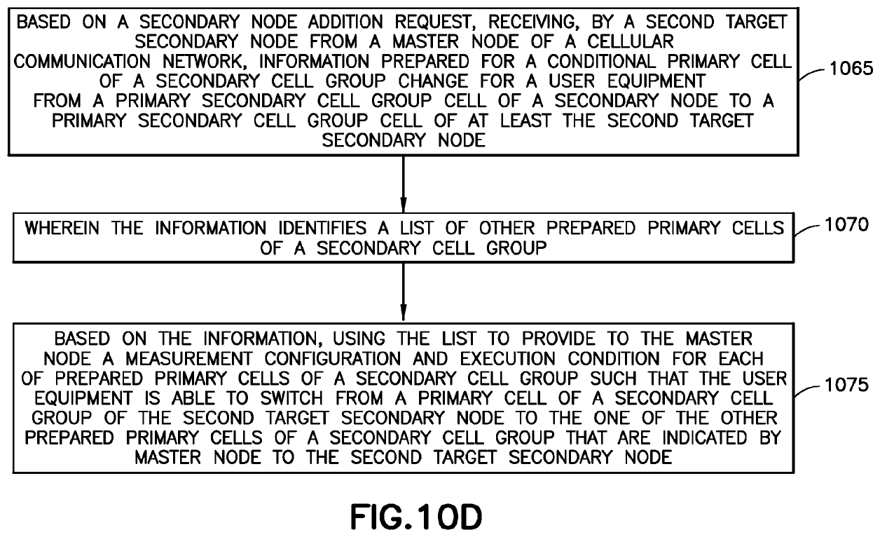

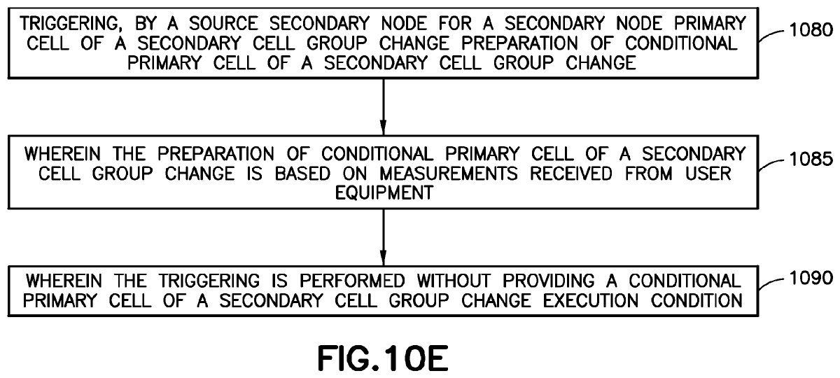

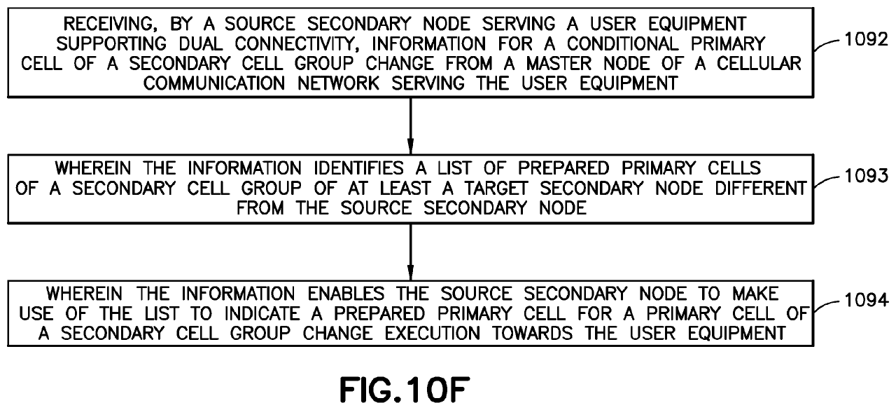

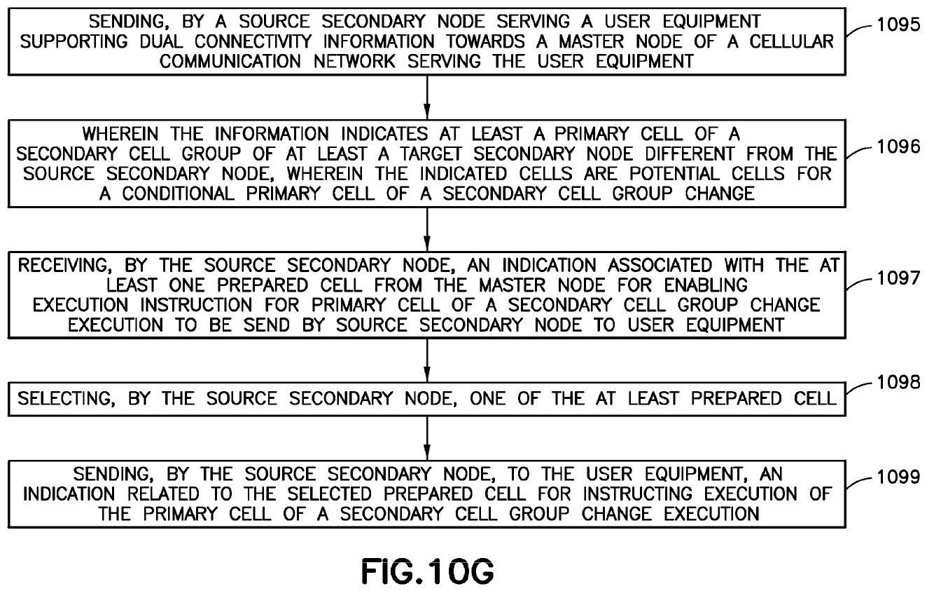

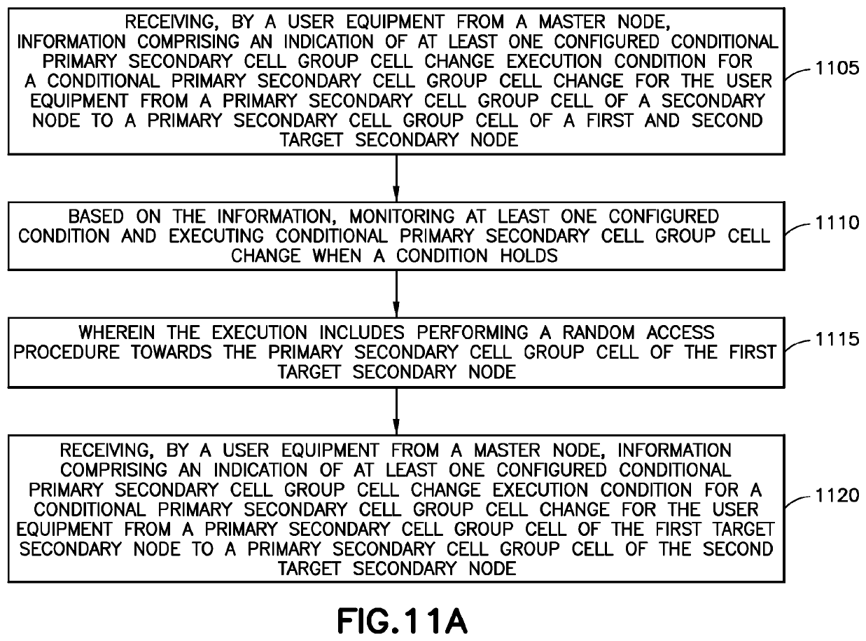

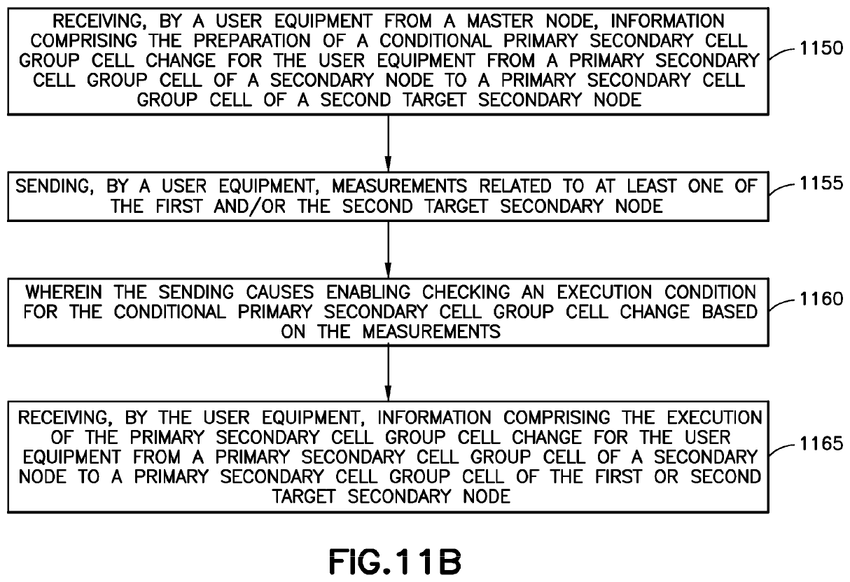

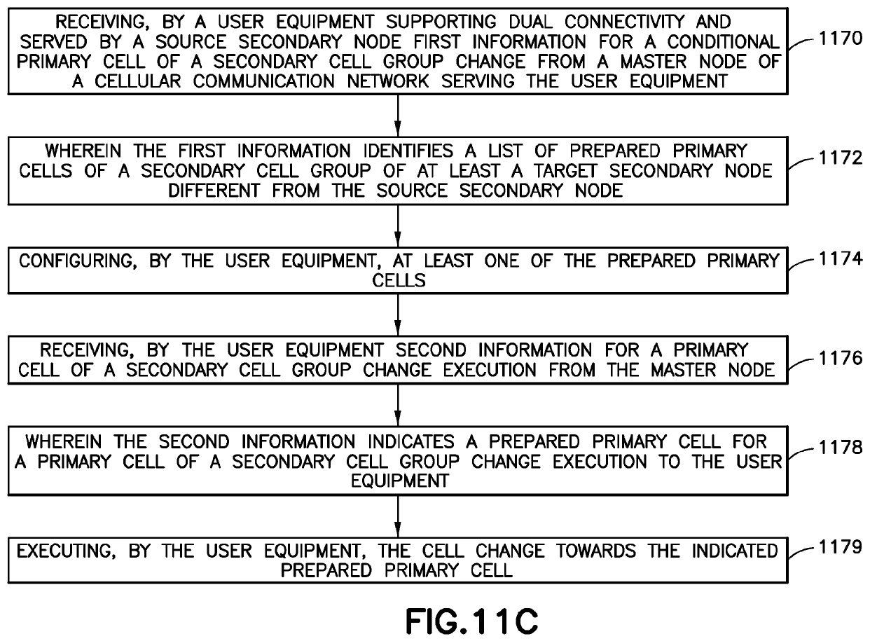

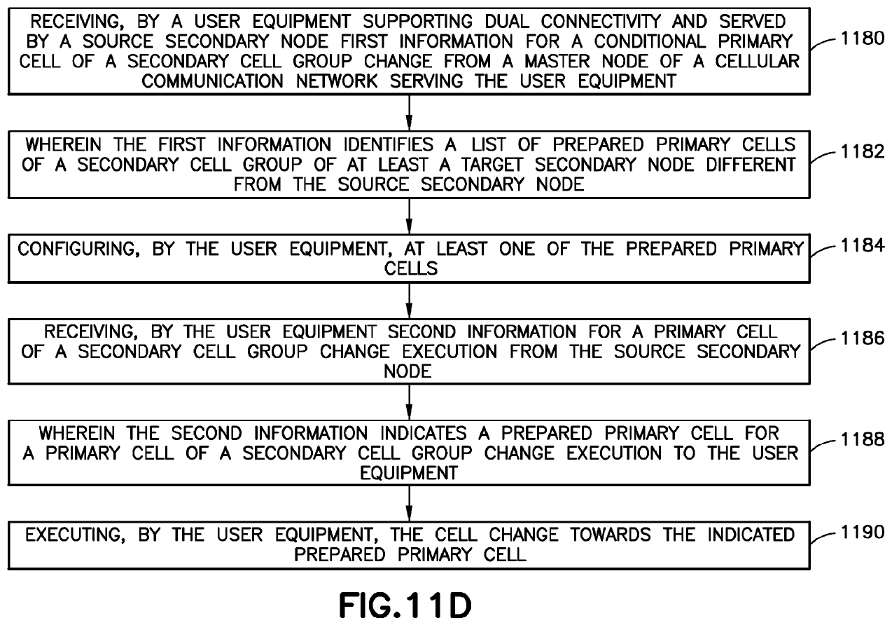

FIG. 9A, FIG. 9B, 9C, 9D, 9E, 10A, 10B, 10C, 10D, 10E, 10F, 10G, 11A, 11B, 11C, and 11D each show a method in accordance with example embodiments of the invention which may be performed by an apparatus

FIG. 9A illustrates operations which may be performed by a device such as, but not limited to, a device (e.g., the Master Node 13 as in FIG. 8). As shown in step 905 of FIG. 9A there is preparing a conditional cell change in a cellular communication network supporting dual connectivity, comprising: As shown in step 910 of FIG. 9A there is sending, by a master node of the cellular communication network, towards a first target secondary node a message comprising an indication of at least one primary cell of a secondary cell group cell of at least a second target secondary node prepared or to be prepared for a conditional primary cell of a secondary cell group change for a user equipment from a primary cell of a secondary cell group of a secondary node to a primary cell of a secondary cell group of at least a second target secondary node. As shown in step 915 of FIG. 9A wherein the message enables, at the first target secondary node, configuration of conditional primary cell of a secondary cell group change execution condition for at least one of the prepared primary cells of a secondary cell group of the at least one second target secondary node for conditional primary cell of a secondary cell group change for the user equipment from a primary cell of a secondary cell group of a first target secondary node to a primary cell of a secondary cell group of at least a second target secondary node;

In accordance with the example embodiments as described in the paragraph above, there is receiving, from the first target secondary node, a message comprising an indication of at least one of the configured conditional primary cell of a secondary cell group change execution conditions; and sending, by the master node, towards the user equipment a message comprising an indication of at least one configured conditional primary cell of a secondary cell group change execution condition.

In accordance with the example embodiments as described in the paragraphs above, there is sending, by the first target secondary node, towards the user equipment a message comprising an indication of at least one configured conditional primary cell of a secondary cell group change execution condition.

In accordance with the example embodiments as described in the paragraphs above, there is a set of updated execution condition and related measurement configuration for at least one of the prepared primary cell of a secondary cell groups.

In accordance with the example embodiments as described in the paragraphs above, there is wherein the information comprises: a conditional primary cell of a secondary cell group change execution condition and updated measurement configurations for the primary cell of a secondary cell groups of the second target secondary node, and at least one of a conditional primary secondary cell group cell addition or change incoming probability for at least one kept conditional primary cell of a secondary cell group associated with the first target secondary node and the second target secondary node, and a maximum number of primary cell of a secondary cell group cells supported by the first target secondary node.

In accordance with the example embodiments as described in the paragraphs above, wherein the set of updated execution conditions and updated measurement configurations are included in a secondary node modification required request sent from the first target secondary node and received by the master node.

In accordance with the example embodiments as described in the paragraphs above, wherein the incoming probability for at least one kept conditional primary cell of a secondary cell group change and the maximum number of primary secondary cell group cells are included in a secondary node modification request sent from the master node towards the second target secondary node.

In accordance with the example embodiments as described in the paragraphs above, wherein the method further comprises: receiving, by the master node a message from the user equipment comprising an indication that the user equipment executes a conditional primary cell of a secondary cell group change towards a primary cell of a secondary cell group cell of the first target secondary node.

A non-transitory computer-readable medium (MEM 13B as in FIG. 8) storing program code (PROG 13C as in FIG. 8), the program code executed by at least one processor (DP 13A as in FIG. 8) to perform the operations as at least described in the paragraphs above.

In accordance with an example embodiment of the invention as described above there is an apparatus comprising: means for preparing (TRANS 13D, MEM 13B, PROG 13C, and DP 13A as in FIG. 8) a conditional cell change in a cellular communication network (NETWORK 1 as in FIG. 8) supporting dual connectivity, comprising: means for sending (TRANS 13D, MEM 13B, PROG 13C, and DP 13A as in FIG. 8), by a master node (Master Node 13 as in FIG. 8) of the cellular communication network, towards a first target secondary node (Secondary Node 5 and/or Secondary Node 12 as in FIG. 8) a message comprising an indication of at least one primary cell of a secondary cell group cell of at least a second target secondary node prepared or to be prepared for a conditional primary cell of a secondary cell group change for a user equipment (UE 10 as in FIG. 8) from a primary cell of a secondary cell group of a secondary node to a primary cell of a secondary cell group of at least a second target secondary node, wherein the message enables (TRANS 13D, MEM 13B, PROG 13C, and DP 13A as in FIG. 8), at the first target secondary node, configuration of conditional primary cell of a secondary cell group change execution condition for at least one of the prepared primary cells of a secondary cell group of the at least one second target secondary node for conditional primary cell of a secondary cell group change for the user equipment from a primary cell of a secondary cell group of a first target secondary node to a primary cell of a secondary cell group of at least a second target secondary node;

In the example aspect of the invention according to the paragraph above, wherein at least the means for preparing, sending, and enabling comprises a non-transitory computer readable medium [MEM 13B as in FIG. 8] encoded with a computer program [PROG 13C as in FIG. 8] executable by at least one processor [DP 13A as in FIG. 8].

FIG. 9B illustrates operations which may be performed by a device such as, but not limited to, a device (e.g., the Master Node 13 as in FIG. 8). As shown in step 930 of FIG. 9B there is sending, by a master node of a cellular communication network, information towards a second target secondary node prepared for a conditional primary cell of a secondary cell group change for a user equipment from a primary secondary cell group cell of a secondary node to a primary secondary cell group cell of the second target secondary node. As shown in step 935 of FIG. 9B wherein the information includes at least one prepared primary secondary cell group cell of a first target secondary node. As show in step 940 of FIG. 9B wherein the information enables the second target secondary node to provide an execution condition for a conditional primary cell of a secondary cell group change from a primary secondary cell group cell of the second target secondary node to a primary secondary cell group cell of the first target secondary node. Then as shown in step 942 of FIG. 9B there is receiving by the master node at least one configuration including an execution condition for a conditional primary cell of a secondary cell group change from a primary secondary cell group cell of the second target secondary node to a primary secondary cell group cell of the first target secondary node in case a conditional primary cell of a secondary cell group change is executed for the user equipment from the secondary node towards the second target secondary node.

In accordance with the example embodiments as described in the paragraphs above, there is based on the sending, receiving from the second target secondary node at least one of: a first configuration to be used if the conditional primary cell of a secondary cell group change is executed towards a first cell of the second target secondary node, or a second configuration to be used if the conditional primary cell of a secondary cell group change is executed towards a second cell of the second target secondary node.

In accordance with the example embodiments as described in the paragraphs above, wherein the first configuration and the second configuration comprise measurement configurations for conditional primary cell of a secondary cell group execution conditions associated with a conditional primary secondary cell group cell addition or change incoming probability from a first target secondary node to the second target secondary node, or vice versa.

In accordance with the example embodiments as described in the paragraphs above, receiving from the first target secondary node information comprising a configuration for the primary cell of a secondary cell group, wherein the information comprises a conditional primary cell of a secondary cell group execution condition from the first target secondary node to the second target secondary node, or vice versa.

In accordance with the example embodiments as described in the paragraphs above, wherein the information comprises a measurement configuration comprising a configuration of conditional primary cell of a secondary cell group execution conditions, and a conditional primary secondary cell group cell addition or change incoming probability from a first target secondary node to the second target secondary node, or vice versa.

A non-transitory computer-readable medium (MEM 13B as in FIG. 8) storing program code (PROG 13C as in FIG. 8), the program code executed by at least one processor (DP 13A as in FIG. 8) to perform the operations as at least described in the paragraphs above.

In accordance with an example embodiment of the invention as described above there is an apparatus comprising: means for sending (TRANS 13D, MEM 13B, PROG 13C, and DP 13A as in FIG. 8), by a master node (Master Node 13 as in FIG. 8) of a cellular communication network (NETWORK 1 as in FIG. 8), information towards a second target secondary node (Secondary Node 5 and/or Secondary Node 12 as in FIG. 8) prepared for a conditional primary cell of a secondary cell group change for a user equipment (UE 10 as in FIG. 8) from a primary secondary cell group cell of a secondary node to a primary secondary cell group cell of the second target secondary node, wherein the information includes at least one prepared primary secondary cell group cell of a first target secondary node, and wherein the information enables (TRANS 13D, MEM 13B, PROG 13C, and DP 13A as in FIG. 8) the second target secondary node to provide an execution condition for a conditional primary cell of a secondary cell group change from a primary secondary cell group cell of the second target secondary node to a primary secondary cell group cell of the first target secondary node; means for receiving (TRANS 13D, MEM 13B, PROG 13C, and DP 13A as in FIG. 8) by the master node at least one configuration including an execution condition for a conditional primary cell of a secondary cell group change from a primary secondary cell group cell of the second target secondary node to a primary secondary cell group cell of the first target secondary node in case a conditional primary cell of a secondary cell group change is executed for the user equipment from the secondary node towards the second target secondary node.

In the example aspect of the invention according to the paragraph above, wherein at least the means for sending, enabling, and receiving comprises a non-transitory computer readable medium [MEM 13B as in FIG. 8] encoded with a computer program [PROG 13C as in FIG. 8] executable by at least one processor [DP 13A as in FIG. 8].

FIG. 9C illustrates operations which may be performed by a device such as, but not limited to, a device (e.g., the Master Node 13 as in FIG. 8). As shown in step 950 of FIG. 9C there is sending, by a master node of a cellular communication network, information towards a source secondary node. As shown in step 955 of FIG. 9C wherein the information identifies a list of other prepared primary cells of a secondary cell group. Then as shown in step 960 of FIG. 9C wherein the information enables the second target secondary node to make use of the list to indicate primary cells of a secondary cell group change to the user equipment.

In accordance with the example embodiments as described in the paragraph above, there is sending towards the user equipment a radio resource control reconfiguration message comprising a radio resource control reconfiguration and a secondary node command for a cell change.

In accordance with the example embodiments as described in the paragraphs above, there is based on the radio resource control reconfiguration message, receiving from the user equipment a radio resource control reconfiguration complete message.

A non-transitory computer-readable medium (MEM 13B as in FIG. 8) storing program code (PROG 13C as in FIG. 8), the program code executed by at least one processor (DP 13A as in FIG. 8) to perform the operations as at least described in the paragraph above.

In accordance with an example embodiment of the invention as described above there is an apparatus comprising: means for sending (TRANS 13D, MEM 13B, PROG 13C, and DP 13A as in FIG. 8), by a master node (Master Node 13 as in FIG. 8) of a cellular communication network (NETWORK 1 as in FIG. 8), information towards a source secondary node (Secondary Node 5 and/or Secondary Node 12 as in FIG. 8), wherein the information identifies (TRANS 13D, MEM 13B, PROG 13C, and DP 13A as in FIG. 8) a list of other prepared primary cells of a secondary cell group, and wherein the information enables (TRANS 13D, MEM 13B, PROG 13C, and DP 13A as in FIG. 8) the second target secondary node to make use of the list to indicate primary cells of a secondary cell group change to the user equipment.

In the example aspect of the invention according to the paragraph above, wherein at least the means for sending, identifying, and enabling comprises a non-transitory computer readable medium [MEM 13B as in FIG. 8] encoded with a computer program [PROG 13C as in FIG. 8] executable by at least one processor [DP 13A as in FIG. 8].

FIG. 9D illustrates operations which may be performed by a device such as, but not limited to, a device (e.g., the Master Node 13 as in FIG. 8). As shown in step 965 of FIG. 9D there is receiving, by a master node of a cellular communication network, information from a source secondary node. As shown in step 970 of FIG. 9D wherein the information identifies at least a prepared primary cell of a secondary cell group. Then as shown in step 975 of FIG. 9D wherein the information causes the master target secondary node to indicate to the UE primary cells of a secondary cell group change towards the cell indicated with the information.

A non-transitory computer-readable medium (MEM 13B as in FIG. 8) storing program code (PROG 13C as in FIG. 8), the program code executed by at least one processor (DP 13A as in FIG. 8) to perform the operations as at least described in the paragraph above.

In accordance with an example embodiment of the invention as described above there is an apparatus comprising: means for receiving (TRANS 13D, MEM 13B, PROG 13C, and DP 13A as in FIG. 8), by a master node (Master Node 13 as in FIG. 8) of a cellular communication network (NETWORK 1 as in FIG. 8), information from a source secondary node (Secondary Node 5 and/or Secondary Node 12 as in FIG. 8, wherein the information identifies (TRANS 13D, MEM 13B, PROG 13C, and DP 13A as in FIG. 8) at least a prepared primary cell of a secondary cell group, and wherein the information causes (TRANS 13D, MEM 13B, PROG 13C, and DP 13A as in FIG. 8) the master target secondary node to indicate to the user equipment primary cells of a secondary cell group change towards the cell indicated with the information.

In the example aspect of the invention according to the paragraph above, wherein at least the means for receiving, identifying, and causing comprises a non-transitory computer readable medium [MEM 13B as in FIG. 8] encoded with a computer program [PROG 13C as in FIG. 8] executable by at least one processor [DP 13A as in FIG. 8].

FIG. 9E illustrates operations which may be performed by a device such as, but not limited to, a device (e.g., the Master Node 13 as in FIG. 8). As shown in step 977 of FIG. 9E there is receiving, by a master node of a cellular communication network serving a user equipment supporting dual connectivity, information from a source secondary node serving the user equipment. As shown in step 978 of FIG. 9E wherein the information indicates at least a primary cell of a secondary cell group of at least a target secondary node different from the source secondary node, wherein the indicated cells are potential cells for a conditional primary cell of a secondary cell group change. As shown in step 979 of FIG. 9E there is triggering, by the master node, preparation of the indicated cells at the at least one target secondary node. As shown in step 980 of FIG. 9E there is sending, by the master node to the user equipment at least one prepared primary cell for a conditional primary cell of secondary cell group change. Then as shown in step 982 of FIG. 9E there is sending, by the master node, to the source secondary node an indication associated with the at least one prepared cell for enabling execution instruction for primary cell of a secondary cell group change execution to be send by source secondary node to user equipment.

In accordance with the example embodiments as described in the paragraphs above, there is sending towards the user equipment a radio resource control reconfiguration message comprising a radio resource control reconfiguration and a secondary node command for a cell change.

In accordance with the example embodiments as described in the paragraphs above, there is, based on the radio resource control reconfiguration message, receiving from the user equipment a radio resource control reconfiguration complete message.

In accordance with an example embodiment of the invention as described above there is an apparatus comprising: means for receiving (TRANS 13D, MEM 13B, PROG 13C, and DP 13A as in FIG. 8), by a master node (Master Node 13 as in FIG. 8) of a cellular communication network (NETWORK 1 as in FIG. 8) serving a user equipment (UE 10 as in FIG. 8) supporting dual connectivity, information from a source secondary node serving the user equipment, wherein the information indicates (TRANS 13D, MEM 13B, PROG 13C, and DP 13A as in FIG. 8) at least a primary cell of a secondary cell group of at least a target secondary node different from the source secondary node, wherein the indicated cells are potential cells for a conditional primary cell of a secondary cell group change; means for triggering (TRANS 13D, MEM 13B, PROG 13C, and DP 13A as in FIG. 8), by the master node, preparation of the indicated cells at the at least one target secondary node; means for sending (TRANS 13D, MEM 13B, PROG 13C, and DP 13A as in FIG. 8), by the master node to the user equipment at least one prepared primary cell for a conditional primary cell of secondary cell group change; then means for sending (TRANS 13D, MEM 13B, PROG 13C, and DP 13A as in FIG. 8), by the master node, to the source secondary node an indication associated with the at least one prepared cell for enabling execution instruction for primary cell of a secondary cell group change execution to be send by source secondary node to user equipment.

In the example aspect of the invention according to the paragraph above, wherein at least the means for receiving, indicating, triggering, and sending comprises a non-transitory computer readable medium [MEM 13B as in FIG. 8] encoded with a computer program [PROG 13C as in FIG. 8] executable by at least one processor [DP 13A as in FIG. 8].

FIG. 10A illustrates operations which may be performed by a device such as, but not limited to, a device (e.g., the Secondary Node 5 and/or a Secondary Node 12 as in FIG. 8). As shown in step 1005 of FIG. 10A there is triggering, by a source secondary node for a secondary node primary cell of a secondary cell group change preparation of conditional primary cell of a secondary cell group change. As shown in step 1010 of FIG. 10A, wherein the preparation of conditional primary cell of a secondary cell group change is based on measurements received from user equipment. Then as shown in step 1015 of FIG. 10A wherein the triggering is performed without providing a conditional primary cell of a secondary cell group change execution condition.

In accordance with the example embodiments as described in the paragraph above, there is sending towards a master node information comprising at least one of a global or physical cell identity of a prepared target primary cell of a secondary cell group for the primary cell change execution for the user equipment.

In accordance with the example embodiments as described in the paragraphs above, there is receiving from the master node an identification of conditional reconfigurations that are associated with the prepared target primary cell of the secondary cell group.

In accordance with the example embodiments as described in the paragraphs above, there is based on the receiving, sending towards the user equipment a radio resource control reconfiguration command and an identification instructing the user equipment to execute the conditional reconfigurations of a specific target primary cell of a secondary cell group identified by the identification.

A non-transitory computer-readable medium (MEM 5B and/or MEM 12B as in FIG. 8) storing program code (PROG 5C and/or PROG 12C as in FIG. 8), the program code executed by at least one processor (DP 5A and/or DP 12A as in FIG. 8) to perform the operations as at least described in the paragraphs above.

In accordance with an example embodiment of the invention as described above there is an apparatus comprising: means for triggering (TRANS 5D and/or TRANS 12D; MEM 5B and/or MEM 12B; PROG 5C and/or PROG 12C; and DP 5A and/or DP 12A as in FIG. 8), by a source secondary node (Secondary Node 5 and/or Secondary Node 12 as in FIG. 8) for a secondary node primary cell of a secondary cell group change preparation of conditional primary cell of a secondary cell group change, wherein the preparation (TRANS 5D and/or TRANS 12D; MEM 5B and/or MEM 12B; PROG 5C and/or PROG 12C; and DP 5A and/or DP 12A as in FIG. 8) of conditional primary cell of a secondary cell group change is based on measurements received from user equipment, and wherein the triggering (TRANS 5D and/or TRANS 12D; MEM 5B and/or MEM 12B; PROG 5C and/or PROG 12C; and DP 5A and/or DP 12A as in FIG. 8) is performed without providing a conditional primary cell of a secondary cell group change execution condition.

In the example aspect of the invention according to the paragraph above, wherein at least the means for triggering and preparing comprises a non-transitory computer readable medium [MEM 5B and/or MEM 12B as in FIG. 8] encoded with a computer program [PROG 5C and/or PROG 12C as in FIG. 8] executable by at least one processor [DP 5A and/or DP 12A as in FIG. 8].

FIG. 10B illustrates other operations which may be performed by a device such as, but not limited to, a device (e.g., the Secondary Node 5 and/or a Secondary Node 12 as in FIG. 8). As shown in step 1020 of FIG. 10B there is preparing a conditional cell change in a cellular communication network supporting dual connectivity, comprising: As shown in step 1025 of FIG. 10B there is receiving, by a first target secondary node of the cellular communication network, from a master node a message comprising an indication of at least one primary secondary cell group cell of at least a second target secondary node prepared for a conditional primary cell of a secondary cell group change for a user equipment from a primary secondary cell group cell of a secondary node to a primary secondary cell group cell of at least a second target secondary node. As shown in step 1030 of FIG. 10B there is wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node. As shown in step 1040 of FIG. 10B there is sending, towards the master nide, a message comprising an indication of at least one of the configured conditional primary cell of a secondary cell group change execution conditions. Then as shown in step 1045 of FIG. 10B wherein the sending causes an indication of at least one configured conditional primary cell of a secondary cell group change execution condition to be sent towards the user equipment.

In accordance with the example embodiments as described in the paragraph above, there is sending towards the master node information comprising a set of updated execution condition and related measurement configuration for each of the prepared primary secondary cell group cells.

In accordance with the example embodiments as described in the paragraphs above, wherein the information comprises: a conditional primary cell of a secondary cell group change execution condition and updated measurement configurations for the primary secondary cell group cells for the first target secondary node and the second target secondary node, and at least one conditional primary secondary cell group cell addition or change incoming probability for at least one kept conditional primary cell of a secondary cell group change associated with the first target secondary node and the second target secondary node and for a maximum number of primary secondary cell group cells that can be initiated by the second target secondary node.

In accordance with the example embodiments as described in the paragraphs above, wherein the set of updated execution conditions and updated measurement configurations are at least based on a secondary node modification required request sent from the first target secondary node to the master node.

A non-transitory computer-readable medium (MEM 5B and/or MEM 12B as in FIG. 8) storing program code (PROG 5C and/or PROG 12C as in FIG. 8), the program code executed by at least one processor (DP 5A and/or DP 12A as in FIG. 8) to perform the operations as at least described in the paragraphs above.

In accordance with an example embodiment of the invention as described above there is an apparatus comprising: means for preparing (TRANS 5D and/or TRANS 12D; MEM 5B and/or MEM 12B; PROG 5C and/or PROG 12C; and DP 5A and/or DP 12A as in FIG. 8) a conditional cell change in a cellular communication network supporting dual connectivity, comprising: means for receiving (TRANS 5D and/or TRANS 12D; MEM 5B and/or MEM 12B; PROG 5C and/or PROG 12C; and DP 5A and/or DP 12A as in FIG. 8), by a first target secondary node (Secondary Node 5 and/or Secondary Node 12 as in FIG. 8) of the cellular communication network (NETWORK 1 as in FIG. 8), from a master node (Master Node 13 as in FIG. 8) a message comprising an indication of at least one primary secondary cell group cell of at least a second target secondary node prepared for a conditional primary cell of a secondary cell group change for a user equipment from a primary secondary cell group cell of a secondary node to a primary secondary cell group cell of at least a second target secondary node, wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node; means for sending (TRANS 5D and/or TRANS 12D; MEM 5B and/or MEM 12B; PROG 5C and/or PROG 12C; and DP 5A and/or DP 12A as in FIG. 8), towards the master nide, a message comprising an indication of at least one of the configured conditional primary cell of a secondary cell group change execution conditions, wherein the sending causes an indication of at least one configured conditional primary cell of a secondary cell group change execution condition to be sent towards the user equipment.

In the example aspect of the invention according to the paragraph above, wherein at least the means for receiving and sending comprises a non-transitory computer readable medium [MEM 5B and/or MEM 12B as in FIG. 8] encoded with a computer program [PROG 5C and/or PROG 12C as in FIG. 8] executable by at least one processor [DP 5A and/or DP 12A as in FIG. 8].

FIG. 10C illustrates other operations which may be performed by a device such as, but not limited to, a device (e.g., the Secondary Node 5 and/or a Secondary Node 12 as in FIG. 8). As shown in step 1050 of FIG. 10C there is based on a secondary node addition request, receiving, by a second target secondary node from a master node of a cellular communication network, information prepared for a conditional primary cell of a secondary cell group change for a user equipment from a primary secondary cell group cell of a secondary node to a primary secondary cell group cell of at least the second target secondary node. As shown in step 1055 of FIG. 10C wherein the information identifies a list of other prepared primary cells of a secondary cell group. Then as shown in step 1060 of FIG. 10C there is, based on the information, using the list to provide to the master node a measurement configuration and execution condition for each of prepared primary cells of a secondary cell group such that the user equipment is able to switch from a primary cell of a secondary cell group of the second target secondary node to the one of the other prepared primary cells of a secondary cell group that are indicated by master node to the second target secondary node execution condition

FIG. 10D illustrates other operations which may be performed by a device such as, but not limited to, a device (e.g., the Secondary Node 5 and/or a Secondary Node 12 as in FIG. 8). As shown in step 1065 there is receiving, by a second target secondary node from a master node of a cellular communication network, information prepared for a conditional primary cell of a secondary cell group change for a user equipment from a primary secondary cell group cell of a secondary node to a primary secondary cell group cell of at least the second target secondary node. As shown in step 1070, wherein the information identifies a list of other prepared primary cells of a secondary cell group. Then as shown in step 1075 there is, based on the information, using the list to provide to the master node a measurement configuration and execution condition for each of prepared primary cells of a secondary cell group such that the user equipment is able to switch from a primary cell of a secondary cell group of the second target secondary node to the one of the other prepared primary cells of a secondary cell group that are indicated by master node to the second target secondary node.

In accordance with the example embodiments as described in the paragraph above, there is, based on the receiving, sending towards the master node at least one of: a first configuration to be used if the conditional primary cell of a secondary cell group change is executed towards a first cell of the second target secondary node, or a second configuration to be used if the conditional primary cell of a secondary cell group change is executed towards a second cell of the second target secondary node.

In accordance with the example embodiments as described in the paragraphs above, wherein the second target secondary node makes use of this list to provide a measurement configuration and execution condition for each other prepared primary cells of secondary cell group such that the user equipment is able to switch from the primary cell of secondary cell group of the second target secondary node to the one of the other prepared primary cell of secondary cell group that are indicated by the master node to target second target secondary node

In accordance with the example embodiments as described in the paragraphs above, wherein the first configuration and the second configuration comprise measurement configurations for conditional primary cell of a secondary cell group change execution conditions associated with a conditional primary secondary cell group cell addition or change incoming probability from a first target secondary node to the second target secondary node, or vice versa.

In accordance with the example embodiments as described in the paragraphs above, there is receiving from the first target secondary node information comprising a configuration for the primary cell of a secondary cell group, wherein the information comprises a conditional primary cell of a secondary cell group execution condition from the first target secondary node to the second target secondary node, or vice versa.

In accordance with the example embodiments as described in the paragraphs above, wherein the information comprises a measurement configuration comprising a configuration of conditional primary cell of a secondary cell group execution conditions, and a conditional primary secondary cell group cell addition or change incoming probability from a first target secondary node to the second target secondary node, or vice versa.

A non-transitory computer-readable medium (MEM 5B and/or MEM 12B as in FIG. 8) storing program code (PROG 5C and/or PROG 12C as in FIG. 8), the program code executed by at least one processor (DP 5A and/or DP 12A as in FIG. 8) to perform the operations as at least described in the paragraphs above.

In accordance with an example embodiment of the invention as described above there is an apparatus comprising: means, for receiving (TRANS 5D and/or TRANS 12D; MEM 5B and/or MEM 12B; PROG 5C and/or PROG 12C; and DP 5A and/or DP 12A as in FIG. 8), by a second target secondary node (Secondary Node 5 and/or Secondary Node 12 as in FIG. 8) from a master node (Master Node 13 as in FIG. 8) of a cellular communication network (NETWORK 1 as in FIG. 8), information prepared for a conditional primary cell of a secondary cell group change for a user equipment from a primary secondary cell group cell of a secondary node to a primary secondary cell group cell of at least the second target secondary node, wherein the information identifies a list of other prepared primary cells of a secondary cell group, and based on the information, using (TRANS 5D and/or TRANS 12D; MEM 5B and/or MEM 12B; PROG 5C and/or PROG 12C; and DP 5A and/or DP 12A as in FIG. 8) the list to provide (TRANS 5D and/or TRANS 12D; MEM 5B and/or MEM 12B; PROG 5C and/or PROG 12C; and DP 5A and/or DP 12A as in FIG. 8) to the master node a measurement configuration and execution condition for each of prepared primary cells of a secondary cell group such that the user equipment is able to switch from a primary cell of a secondary cell group of the second target secondary node to the one of the other prepared primary cells of a secondary cell group that are indicated by master node to the second target secondary node.

In the example aspect of the invention according to the paragraph above, wherein at least the means for receiving, using, and providing comprises a non-transitory computer readable medium [MEM 5B and/or MEM 12B as in FIG. 8] encoded with a computer program [PROG 5C and/or PROG 12C as in FIG. 8] executable by at least one processor [DP 5A and/or DP 12A as in FIG. 8].

FIG. 10E illustrates other operations which may be performed by a device such as, but not limited to, a device (e.g., the Secondary Node 5 and/or a Secondary Node 12 as in FIG. 8). As shown in step 1080 there is triggering, by a source secondary node for a secondary node primary cell of a secondary cell group change preparation of conditional primary cell of a secondary cell group change. As shown in step 1085, wherein the preparation of conditional primary cell of a secondary cell group change is based on measurements received from user equipment. Then as shown in step 1090, wherein the triggering is performed without providing a conditional primary cell of a secondary cell group change execution condition.

In accordance with the example embodiments as described in the paragraphs above, there is sending towards a master node information comprising at least one of a global or physical cell identity of a prepared target primary cell of a secondary cell group for the primary cell change execution for the user equipment.

In accordance with the example embodiments as described in the paragraphs above, there is receiving from the master node an identification of conditional reconfigurations that are associated with the prepared target primary cell of the secondary cell group.

In accordance with the example embodiments as described in the paragraphs above, there is, based on the receiving, sending towards the user equipment a radio resource control reconfiguration command and an identification instructing the user equipment to execute the conditional reconfigurations of a specific target primary cell of a secondary cell group identified by the identification.

A non-transitory computer-readable medium (MEM 5B and/or MEM 12B as in FIG. 8) storing program code (PROG 5C and/or PROG 12C as in FIG. 8), the program code executed by at least one processor (DP 5A and/or DP 12A as in FIG. 8) to perform the operations as at least described in the paragraphs above.

In accordance with an example embodiment of the invention as described above there is an apparatus comprising: means for triggering (TRANS 5D and/or TRANS 12D; MEM 5B and/or MEM 12B; PROG 5C and/or PROG 12C; and DP 5A and/or DP 12A as in FIG. 8), by a source secondary node (Secondary Node 5 and/or Secondary Node 12 as in FIG. 8) for a secondary node primary cell of a secondary cell group change preparation of conditional primary cell of a secondary cell group change, wherein the preparation of conditional primary cell of a secondary cell group change is based on measurements received from user equipment, wherein the triggering is performed (TRANS 5D and/or TRANS 12D; MEM 5B and/or MEM 12B; PROG 5C and/or PROG 12C; and DP 5A and/or DP 12A as in FIG. 8) without providing a conditional primary cell of a secondary cell group change execution condition.

In the example aspect of the invention according to the paragraph above, wherein at least the means for triggering and performing comprises a non-transitory computer readable medium [MEM 5B and/or MEM 12B as in FIG. 8] encoded with a computer program [PROG 5C and/or PROG 12C as in FIG. 8] executable by at least one processor [DP 5A and/or DP 12A as in FIG. 8].

FIG. 10F illustrates other operations which may be performed by a device such as, but not limited to, a device (e.g., the Secondary Node 5 and/or a Secondary Node 12 as in FIG. 8). As shown in step 1092 of FIG. 10F there is receiving, by a source secondary node serving a user equipment supporting dual connectivity, information for a conditional primary cell of a secondary cell group change from a master node of a cellular communication network serving the user equipment. As shown in step 1093 of FIG. 10F wherein the information identifies a list of prepared primary cells of a secondary cell group of at least a target secondary node different from the source secondary node. Then as shown in step 1094 of FIG. 10F wherein the information enables the source secondary node to make use of the list to indicate a prepared primary cell for a primary cell of a secondary cell group change execution towards the user equipment.

In accordance with an example embodiment of the invention as described above there is an apparatus comprising: means for receiving (TRANS 5D and/or TRANS 12D; MEM 5B and/or MEM 12B; PROG 5C and/or PROG 12C; and DP 5A and/or DP 12A as in FIG. 8), by a source secondary node (Secondary Node 5 and/or Secondary Node 12 as in FIG. 8) serving a user equipment (UE 10 as in FIG. 8) supporting dual connectivity, information for a conditional primary cell of a secondary cell group change from a master node of a cellular communication network serving the user equipment, wherein the information identifies (TRANS 5D and/or TRANS 12D; MEM 5B and/or MEM 12B; PROG 5C and/or PROG 12C; and DP 5A and/or DP 12A as in FIG. 8) a list of prepared primary cells of a secondary cell group of at least a target secondary node different from the source secondary node, and wherein the information enables (TRANS 5D and/or TRANS 12D; MEM 5B and/or MEM 12B; PROG 5C and/or PROG 12C; and DP 5A and/or DP 12A as in FIG. 8) the source secondary node to make use of the list to indicate a prepared primary cell for a primary cell of a secondary cell group change execution towards the user equipment.

In the example aspect of the invention according to the paragraph above, wherein at least the means for receiving, identifying, and enabling comprises a non-transitory computer readable medium [MEM 5B and/or MEM 12B as in FIG. 8] encoded with a computer program [PROG 5C and/or PROG 12C as in FIG. 8] executable by at least one processor [DP 5A and/or DP 12A as in FIG. 8].

FIG. 10G illustrates other operations which may be performed by a device such as, but not limited to, a device (e.g., the Secondary Node 5 and/or a Secondary Node 12 as in FIG. 8). As shown in step 1095 of FIG. 10G there is sending, by a source secondary node serving a user equipment supporting dual connectivity information towards a master node of a cellular communication network serving the user equipment. As shown in step 1096 of FIG. 10G wherein the information indicates at least a primary cell of a secondary cell group of at least a target secondary node different from the source secondary node, wherein the indicated cells are potential cells for a conditional primary cell of a secondary cell group change. As shown in step 1097 of FIG. 10G there is receiving, by the source secondary node, an indication associated with the at least one prepared cell from the master node for enabling execution instruction for primary cell of a secondary cell group change execution to be send by source secondary node to user equipment. As shown in FIG. 1098 of FIG. 10G there is selecting, by the source secondary node, one of the at least prepared cell. Then as shown in step 1099 of FIG. 10G there is sending, by the source secondary node, to the user equipment, an indication related to the selected prepared cell for instructing execution of the primary cell of a secondary cell group change execution.

In accordance with an example embodiment of the invention as described above there is an apparatus comprising: means for sending (TRANS 5D and/or TRANS 12D; MEM 5B and/or MEM 12B; PROG 5C and/or PROG 12C; and DP 5A and/or DP 12A as in FIG. 8), by a source secondary node (Secondary Node 5 and/or a Secondary Node 12 as in FIG. 8) serving a user equipment (UE 10 as in FIG. 8) supporting dual connectivity information towards a master node of a cellular communication network serving the user equipment, wherein the information indicates (TRANS 5D and/or TRANS 12D; MEM 5B and/or MEM 12B; PROG 5C and/or PROG 12C; and DP 5A and/or DP 12A as in FIG. 8) at least a primary cell of a secondary cell group of at least a target secondary node different from the source secondary node, wherein the indicated cells are potential cells for a conditional primary cell of a secondary cell group change; means for receiving (TRANS 5D and/or TRANS 12D; MEM 5B and/or MEM 12B; PROG 5C and/or PROG 12C; and DP 5A and/or DP 12A as in FIG. 8), by the source secondary node, an indication associated with the at least one prepared cell from the master node for enabling execution instruction for primary cell of a secondary cell group change execution to be send by source secondary node to user equipment; means for selecting (TRANS 5D and/or TRANS 12D; MEM 5B and/or MEM 12B; PROG 5C and/or PROG 12C; and DP 5A and/or DP 12A as in FIG. 8), by the source secondary node, one of the at least prepared cell; then means for sending (TRANS 5D and/or TRANS 12D; MEM 5B and/or MEM 12B; PROG 5C and/or PROG 12C; and DP 5A and/or DP 12A as in FIG. 8), by the source secondary node, to the user equipment, an indication related to the selected prepared cell for instructing execution of the primary cell of a secondary cell group change execution.

In the example aspect of the invention according to the paragraph above, wherein at least the means for sending, indicating, receiving, sending, and selecting comprises a non-transitory computer readable medium [MEM 5B and/or MEM 12B as in FIG. 8] encoded with a computer program [PROG 5C and/or PROG 12C as in FIG. 8] executable by at least one processor [DP 5A and/or DP 12A as in FIG. 8].

FIG. 11A illustrates other operations which may be performed by a device such as, but not limited to, a device (e.g., the UE 10 as in FIG. 8). As shown in step 1105 of FIG. 11A there is receiving, by a user equipment from a master node, information comprising an indication of at least one configured conditional primary cell of a secondary cell group change execution condition for a conditional primary cell of a secondary cell group change for the user equipment from a primary secondary cell group cell of a secondary node to a primary secondary cell group cell of a second target secondary node. As shown in step 1110 of FIG. 11A there is, based on the information, monitoring at least one configured condition and executing conditional primary cell of a secondary cell group change when a condition holds. As shown in step 1115 of FIG. 11A wherein the execution includes performing a random access procedure towards the primary secondary cell group cell of the first target secondary node. Then as shown in step 1120 of FIG. 11A there is receiving, by a user equipment from a master node, information comprising an indication of at least one configured conditional primary cell of a secondary cell group change execution condition for a conditional primary cell of a secondary cell group change for the user equipment from a primary secondary cell group cell of the first target secondary node to a primary secondary cell group cell of the second target secondary node.

A non-transitory computer-readable medium (MEM 10B as in FIG. 8) storing program code (PROG 10C as in FIG. 8), the program code executed by at least one processor (DP 10A as in FIG. 8) to perform the operations as at least described in the paragraphs above.

In accordance with an example embodiment of the invention as described above there is an apparatus comprising: means for receiving (TRANS 10D; MEM 10B; PROG 10C; and DP 10A as in FIG. 8), by a user equipment (UE 10 as in FIG. 8) from a master node (Master Node 13 as in FIG. 8), information comprising an indication of at least one configured conditional primary cell of a secondary cell group change execution condition for a conditional primary cell of a secondary cell group change for the user equipment from a primary secondary cell group cell of a secondary node to a primary secondary cell group cell of a second target secondary node; means, based on the information, for monitoring (TRANS 10D; MEM 10B; PROG 10C; and DP 10A as in FIG. 8) at least one configured condition and executing conditional primary cell of a secondary cell group change when a condition holds, wherein the execution includes performing (TRANS 10D; MEM 10B; PROG 10C; and DP 10A as in FIG. 8) a random access procedure towards the primary secondary cell group cell of the first target secondary node; means for receiving (TRANS 10D; MEM 10B; PROG 10C; and DP 10A as in FIG. 8), by a user equipment from a master node, information comprising an indication of at least one configured conditional primary cell of a secondary cell group change execution condition for a conditional primary cell of a secondary cell group change for the user equipment from a primary secondary cell group cell of the first target secondary node to a primary secondary cell group cell of the second target secondary node.

In the example aspect of the invention according to the paragraph above, wherein there is receiving, by a user equipment from a master node, information comprising an indication of at least one configured conditional primary cell of a secondary cell group change execution condition for a conditional primary cell of a secondary cell group change for the user equipment from a primary secondary cell group cell of the first target secondary node to a primary secondary cell group cell of the secondary node.

In the example aspect of the invention according to the paragraph above, wherein at least the means for receiving, monitoring, and performing comprises a non-transitory computer readable medium [MEM 10B as in FIG. 8] encoded with a computer program [PROG 10C as in FIG. 8] executable by at least one processor [DP 10A as in FIG. 8].

FIG. 11B illustrates other operations which may be performed by a device such as, but not limited to, a device (e.g., the UE 10 as in FIG. 8). As shown in step 1150 of FIG. 11B there is receiving, by a user equipment from a master node, information comprising the preparation of a conditional primary cell of a secondary cell group change for the user equipment from a primary secondary cell group cell of a secondary node to a primary secondary cell group cell of a second target secondary node. As shown in step 1155 of FIG. 11B there is sending, by a user equipment, measurements related to at least one of the first and/or the second target secondary node. As shown in step 1160 of FIG. 11B wherein the sending causes enabling checking an execution condition for the conditional primary cell of a secondary cell group change based on the measurements. Then As shown in step 1165 of FIG. 11B there is receiving, by the user equipment, information comprising the execution of the primary cell of a secondary cell group change for the user equipment from a primary secondary cell group cell of a secondary node to a primary secondary cell group cell of the first or second target secondary node.

In accordance with the example embodiments as described in the paragraphs above, there is receiving at least one of a global or physical cell identity of a prepared target primary cell of a secondary cell group for the primary cell change execution for the user equipment.

In accordance with the example embodiments as described in the paragraphs above, there is receiving from the second target secondary node information comprising a configuration for a first primary cell, wherein the configuration adds conditional primary cell of secondary cell group change execution conditions for switching from the first primary cell of secondary cell group to at least one of a second primary cell of secondary cell group.

In accordance with the example embodiments as described in the paragraphs above, wherein the information comprises a conditional primary cell of a secondary cell group addition or change probability from the first primary cell of secondary cell group to at least one of a second primary cell of secondary cell group, or vice versa.

In accordance with the example embodiments as described in the paragraphs above, there is using the configuration to monitoring the conditional primary cell of secondary cell group change execution condition of the configuration from the first primary cell of secondary cell group to the at least one of a second primary cell of secondary cell group.

A non-transitory computer-readable medium (MEM 10B as in FIG. 8) storing program code (PROG 10C as in FIG. 8), the program code executed by at least one processor (DP 10A as in FIG. 8) to perform the operations as at least described in the paragraphs above.

In accordance with an example embodiment of the invention as described above there is an apparatus comprising: means for sending (TRANS 10D; MEM 10B; PROG 10C; and DP 10A as in FIG. 8), by a user equipment (UE 10 as in FIG. 8) towards a source secondary node (Secondary Node 5 and/or Secondary Node 12 as in FIG. 8) of a cellular communication network (Network 1 as in FIG. 8), measurements based on a measurement configuration from a target secondary node, wherein the sending causes triggering (TRANS 10D; MEM 10B; PROG 10C; and DP 10A as in FIG. 8) by the source secondary node for a secondary node primary cell of a secondary cell group change preparation of conditional primary cell of a secondary cell group change, and wherein the triggering is performed without providing a conditional primary cell of a secondary cell group change execution condition.

In the example aspect of the invention according to the paragraph above, wherein at least the means for sending and triggering comprises a non-transitory computer readable medium [MEM 10B as in FIG. 8] encoded with a computer program [PROG 10C as in FIG. 8] executable by at least one processor [DP 10A as in FIG. 8].

FIG. 11C illustrates other operations which may be performed by a device such as, but not limited to, a device (e.g., the UE 10 as in FIG. 8). As shown in step 1170 of FIG. 11C there is receiving, by a user equipment supporting dual connectivity and served by a source secondary node first information for a conditional primary cell of a secondary cell group change from a master node of a cellular communication network serving the user equipment. As shown in step 1172 of FIG. 11C wherein the first information identifies a list of prepared primary cells of a secondary cell group of at least a target secondary node different from the source secondary node. As shown in step 1174 of FIG. 11C there is configuring, by the user equipment, at least one of the prepared primary cells. As shown in step 1176 of FIG. 11C there is receiving, by the user equipment second information for a primary cell of a secondary cell group change execution from the master node. As shown in step 1178 of FIG. 11C wherein the second information indicates a prepared primary cell for a primary cell of a secondary cell group change execution to the user equipment. Then as shown in step 1179 of FIG. 11C there is executing, by the user equipment, the cell change towards the indicated prepared primary cell.

In accordance with an example embodiment of the invention as described above there is an apparatus comprising: means for receiving (TRANS 10D; MEM 10B; PROG 10C; and DP 10A as in FIG. 8), by a user equipment (UE 10 as in FIG. 8) supporting dual connectivity and served by a source secondary node first information for a conditional primary cell of a secondary cell group change from a master node of a cellular communication network serving the user equipment, wherein the first information identifies (TRANS 10D; MEM 10B; PROG 10C; and DP 10A as in FIG. 8) a list of prepared primary cells of a secondary cell group of at least a target secondary node different from the source secondary node; means for configuring (TRANS 10D; MEM 10B; PROG 10C; and DP 10A as in FIG. 8), by the user equipment, at least one of the prepared primary cells; means for receiving ( ) by the user equipment second information for a primary cell of a secondary cell group change execution from the master node, wherein the second information indicates (TRANS 10D; MEM 10B; PROG 10C; and DP 10A as in FIG. 8) a prepared primary cell for a primary cell of a secondary cell group change execution to the user equipment; then means for executing (TRANS 10D; MEM 10B; PROG 10C; and DP 10A as in FIG. 8), by the user equipment, the cell change towards the indicated prepared primary cell.

In the example aspect of the invention according to the paragraph above, wherein at least the means for receiving, identifying, configuring, indicating, and executing comprises a non-transitory computer readable medium [MEM 10B as in FIG. 8] encoded with a computer program [PROG 10C as in FIG. 8] executable by at least one processor [DP 10A as in FIG. 8].

FIG. 11D illustrates other operations which may be performed by a device such as, but not limited to, a device (e.g., the UE 10 as in FIG. 8). As shown in step 1180 of FIG. 11D there is receiving, by a user equipment supporting dual connectivity and served by a source secondary node first information for a conditional primary cell of a secondary cell group change from a master node of a cellular communication network serving the user equipment. As shown in step 1182 of FIG. 11D wherein the first information identifies a list of prepared primary cells of a secondary cell group of at least a target secondary node different from the source secondary node. As shown in step 1184 of FIG. 11D there is configuring, by the user equipment, at least one of the prepared primary cells. As shown in step 1186 of FIG. 11D there is receiving, by the user equipment second information for a primary cell of a secondary cell group change execution from the source secondary node. As shown in step 1188 of FIG. 11D wherein the second information indicates a prepared primary cell for a primary cell of a secondary cell group change execution to the user equipment. Then as shown in step 1190 of FIG. 11D there is executing, by the user equipment, the cell change towards the indicated prepared primary cell.

In accordance with an example embodiment of the invention as described above there is an apparatus comprising: means for receiving (TRANS 10D; MEM 10B; PROG 10C; and DP 10A as in FIG. 8), by a user equipment (UE 10 as in FIG. 8) supporting dual connectivity and served by a source secondary node (Secondary Node 5 and/or Secondary Node 12 as in FIG. 8) first information for a conditional primary cell of a secondary cell group change from a master node of a cellular communication network serving the user equipment, wherein the first information identifies (TRANS 10D; MEM 10B; PROG 10C; and DP 10A as in FIG. 8) a list of prepared primary cells of a secondary cell group of at least a target secondary node different from the source secondary node; means for configuring (TRANS 10D; MEM 10B; PROG 10C; and DP 10A as in FIG. 8), by the user equipment, at least one of the prepared primary cells; means for receiving (TRANS 10D; MEM 10B; PROG 10C; and DP 10A as in FIG. 8), by the user equipment second information for a primary cell of a secondary cell group change execution from the source secondary node, wherein the second information indicates (TRANS 10D; MEM 10B; PROG 10C; and DP 10A as in FIG. 8) a prepared primary cell for a primary cell of a secondary cell group change execution to the user equipment; and means for executing (TRANS 10D; MEM 10B; PROG 10C; and DP 10A as in FIG. 8), by the user equipment, the cell change towards the indicated prepared primary cell.

In the example aspect of the invention according to the paragraph above, wherein at least the means for receiving, identifying, configuring, indicating, and executing comprises a non-transitory computer readable medium [MEM 10B as in FIG. 8] encoded with a computer program [PROG 10C as in FIG. 8] executable by at least one processor [DP 10A as in FIG. 8].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

Further details, e.g. description of CPC (Conditional PSCell Change), Radio Resource Configuration (RRC), Dual Connectivity (DC) and related procedures, are e.g. described in 3GPP TS 37.340 v 16.8.0 (2021-12), in particular sections 10.5 Secondary Node Change (MN/SN initiated), 10.5.2 MR-DC with 5GC, 10.6 PSCell change, 10.10.2 MR-DC with 5GC, 10.3.2 MR-DC with 5GC and TS38.331 v 16.7.0 (2021-12), in particular sections 5.5.4 Measurement report triggering, 5.5.5 Measurement reporting, 5.3.5 RRC reconfiguration, 4.4 Functions, 5.2 System Information, 5.2.1 Introduction, 5.7.2a UL information transfer for MR-DC, 6.3.2 Radio resource control information elements e.g. ConditionalReconfiguration: The IE ConditionalReconfiguration is used to add, modify and release the configuration of conditional reconfiguration, which are incorporated herein by reference, and which may be modified and/or adapted in future releases using the above description of one or more embodiments.

1-65. (canceled)

66. A method, comprising:
preparing a conditional cell change in a cellular communication network supporting dual connectivity, comprising:
sending, by a master node of the cellular communication network, towards a first target secondary node a message comprising an indication of at least one primary cell of a secondary cell group of at least a second target secondary node prepared or to be prepared for a conditional primary cell of a secondary cell group change for a user equipment from a primary cell of a secondary cell group of a secondary node to a primary cell of a secondary cell group of at least a second target secondary node,
wherein the message enables, at the first target secondary node, configuration of conditional primary cell of a secondary cell group change execution condition for at least one of the prepared primary cells of a secondary cell group of the at least one second target secondary node for conditional primary cell of a secondary cell group change for the user equipment from a primary cell of a secondary cell group of the first target secondary node to a primary cell of a secondary cell group of at least a second target secondary node.

67. The method of claim 66, comprising:
receiving, from the first target secondary node, a message comprising an indication of at least one of the configured conditional primary cell of a secondary cell group change execution conditions; and
sending, by the master node, towards the user equipment a message comprising an indication of at least one configured conditional primary cell of a secondary cell group change execution condition.

68. The method of claim 66, comprising:
sending, by the first target secondary node, towards the user equipment a message comprising an indication of at least one configured conditional primary cell of a secondary cell group change execution condition, wherein the first target secondary node can act as a source target secondary node.

69. The method of claim 67, wherein the indication comprises:
a set of updated execution condition and related measurement configuration for at least one of the prepared primary cell of a secondary cell groups.

70. The method of claim 69, wherein the indication further comprises:
a conditional primary cell of a secondary cell group change execution condition and updated measurement configurations for the primary cell of a secondary cell groups of the second target secondary node, and
at least one of a conditional primary secondary cell group cell addition or change incoming probability for at least one kept conditional primary cell of a secondary cell group associated with the first target secondary node and the second target secondary node, and a maximum number of primary cell of a secondary cell group cells supported by the first target secondary node.

71. The method of claim 69, wherein the set of updated execution conditions and updated measurement configurations are included in a secondary node modification required request sent from the first target secondary node and received by the master node.

72. The method of claim 70, wherein the incoming probability for at least one kept conditional primary cell of a secondary cell group change and the maximum number of primary secondary cell group cells are included in a secondary node modification request sent from the master node towards the second target secondary node.

73. The method of claim 66, wherein the method further comprises: receiving, by the master node a message from the user equipment comprising an indication that the user equipment executes a conditional primary cell of a secondary cell group change towards a primary cell of a secondary cell group cell of the first target secondary node.

74. A method, comprising:
receiving, by a user equipment supporting dual connectivity and served by a source secondary node first information for a conditional primary cell of a secondary cell group change from a master node of a cellular communication network serving the user equipment,
wherein the first information identifies a list of prepared primary cells of a secondary cell group of at least a target secondary node different from the source secondary node,
configuring, by the user equipment, at least one of the prepared primary cells,
receiving, by the user equipment second information for a primary cell of a secondary cell group change execution from the master node,
wherein the second information indicates a prepared primary cell for a primary cell of a secondary cell group change execution to the user equipment, and
executing, by the user equipment, the cell change towards the indicated prepared primary cell.

75. An apparatus for a user equipment supporting dual connectivity, comprising:
at least one processor; and
at least one non-transitory memory including computer program code, where the at least one non-transitory memory and the computer program code are configured, with the at least one processor, to cause the apparatus to at least:
receive, by the user equipment served by a source secondary node first information for a conditional primary cell of a secondary cell group change from a master node of a cellular communication network serving the user equipment,
wherein the first information identifies a list of prepared primary cells of a secondary cell group of at least a target secondary node different from the source secondary node,
configure, by the user equipment, at least one of the prepared primary cells;
receive by the user equipment second information for a primary cell of a secondary cell group change execution from the master node,
wherein the second information indicates a prepared primary cell for a primary cell of a secondary cell group change execution to the user equipment; and
execute, by the user equipment, the cell change towards the indicated prepared primary cell.

76. An apparatus for a master node of the cellular communication network, comprising:
at least one processor; and
at least one non-transitory memory including computer program code, where the at least one non-transitory memory and the computer program code are configured, with the at least one processor, to cause the apparatus to at least:
send towards a first target secondary node a message comprising an indication of at least one primary cell of a secondary cell group of at least a second target secondary node prepared or to be prepared for a conditional primary cell of a secondary cell group change for a user equipment from a primary cell of a secondary cell group of a secondary node to a primary cell of a secondary cell group of at least a second target secondary node,
wherein the message enables, at the first target secondary node, configuration of conditional primary cell of a secondary cell group change execution condition for at least one of the prepared primary cells of a secondary cell group of the at least one second target secondary node for conditional primary cell of a secondary cell group change for the user equipment from a primary cell of a secondary cell group of a first target secondary node to a primary cell of a secondary cell group of at least a second target secondary node.

77. A method, comprising:
preparing a conditional cell change in a cellular communication network supporting dual connectivity, comprising:
receiving, by a first target secondary node of the cellular communication network, from a master node a message comprising an indication of at least one primary secondary cell group cell of at least a second target secondary node prepared for a conditional primary cell of a secondary cell group change for a user equipment from a primary secondary cell group cell of a secondary node to a primary secondary cell group cell of at least a second target secondary node,
wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node;
sending, towards the master node, a message comprising an indication of at least one of the configured conditional primary cell of a secondary cell group change execution conditions, and
wherein the sending causes an indication of at least one configured conditional primary cell of a secondary cell group change execution condition to be sent towards the user equipment, or
sending towards the user equipment, a message comprising an indication of at least one of the configured conditional primary cell of a secondary cell group change execution conditions.

78. The method of claim 77, comprising:
sending towards the master node information comprising a set of updated execution condition and related measurement configuration for each of the prepared primary secondary cell group cells.

79. The method of claim 78, wherein the information comprises:
a conditional primary cell of a secondary cell group change execution condition and updated measurement configurations for the primary secondary cell group cells for the first target secondary node and the second target secondary node, and
at least one conditional primary secondary cell group cell addition or change incoming probability for at least one kept conditional primary cell of a secondary cell group change associated with the first target secondary node and the second target secondary node and for a maximum number of primary secondary cell group cells that can be initiated by the second target secondary node.

80. The method of claim 79, wherein the set of updated execution conditions and updated measurement configurations are at least based on a secondary node modification required request sent from the first target secondary node to the master node.

81. An apparatus, comprising:
at least one processor; and
at least one non-transitory memory including computer program code, where the at least one non-transitory memory and the computer program code are configured, with the at least one processor, to cause the apparatus to at least:
prepare a conditional cell change in a cellular communication network supporting dual connectivity, comprising:
receiving, by a first target secondary node of the cellular communication network, from a master node a message comprising an indication of at least one primary secondary cell group cell of at least a second target secondary node prepared for a conditional primary cell of a secondary cell group change for a user equipment from a primary secondary cell group cell of a secondary node to a primary secondary cell group cell of at least a second target secondary node,
wherein the message enables, at the first target secondary node, configuration of conditional primary cell of a secondary cell group change execution condition for at least one of the prepared primary secondary cell group cells of the at least one second target secondary node for conditional primary cell of a secondary cell group change for the user equipment from a primary secondary cell group cell of a first target secondary node to a primary secondary cell group cell of at least a second target secondary node;
sending, towards the master nide, a message comprising an indication of at least one of the configured conditional primary cell of a secondary cell group change execution conditions, and
wherein the sending causes an indication of at least one configured conditional primary cell of a secondary cell group change execution condition to be sent towards the user equipment.
